(19) United States
(12) Patent Application Publication
(10) Pub. No.: US 2011/0288879 A1
(43) Pub. Date: Nov. 24, 2011

(54) SYSTEMS AND METHODS FOR ASSESSING MEDICAL COSTS OF CLAIMS

(76) Inventors: Jon Gice, Hartford, CT (US); Adam Seidner, Hartford, CT (US); Jared Yanowicz, Hartford, CT (US)

(21) Appl. No.: 13/093,820

(22) Filed: Apr. 25, 2011

Related U.S. Application Data
(60) Provisional application No. 61/328,175, filed on Apr. 26, 2010.

(51) Int. Cl. G06Q 50/00; G06Q 10/00

(52) U.S. Cl. 705/2

(57) ABSTRACT

Systems, apparatus, methods and articles of manufacture provide for assessing medical costs of bodily injuries and other medical conditions. In some embodiments, age, comorbidity considerations, or both, may be used in calculating (or otherwise determining) such costs. In some embodiments, a base expected number of units of a projected medical procedure may be multiplied or otherwise adjusted using one or more coefficients, including, but not limited to, an age multiplier and a comorbidity multiplier.

### CROSS-REFERENCE TO RELATED APPLICATIONS

The present application claims the benefit of priority of U.S. Provisional Patent Application No. 61/328,175 filed Apr. 26, 2010, and entitled “Systems and Methods for Assessing Medical Costs of Claims,” which is incorporated by reference in the present application.

### BACKGROUND

Insurance companies, medical care providers and others assess and project the costs associated with providing medical treatment for bodily injuries and other disabilities. Workers compensation insurance carriers, for example, may be required to place funds sufficient to cover the estimated benefits due for an injury claim in a reserve account until the corresponding claim is closed. To assess expected costs, claim professionals may rely on information from a variety of disparate and often lengthy sources and materials, including standard medical guidelines and classification code guides, which may reduce consistency due to the vast amount of different information sources available. Even professionals within the same enterprise may rely on different sources and combinations of such information, potentially reducing consistency. Yet despite the importance of such cost determinations to the insurance and medical industries, previous practices have failed to optimize the information collected to increase the accuracy, consistency and reliability of such cost assessments.

### BRIEF DESCRIPTION OF THE DRAWINGS

An understanding of embodiments described in this disclosure and many of the attendant advantages may be readily obtained by reference to the following detailed description when considered with the accompanying drawings, wherein:

FIG. 1A is a diagram of a system according to some embodiments of the present invention;

FIG. 1B is a diagram of a claim management system according to some embodiments of the present invention;

FIG. 2 is a diagram of a computer system according to some embodiments of the present invention;

FIG. 3 is a diagram of a database according to some embodiments of the present invention;

FIG. 4A is a diagram of a database according to some embodiments of the present invention;

FIG. 4B is a diagram of a database according to some embodiments of the present invention;

FIG. 5 is a diagram of a database according to some embodiments of the present invention;

FIG. 6 is a flowchart of a method according to some embodiments of the present invention;

FIG. 7 is a flowchart of a method according to some embodiments of the present invention;

FIG. 8 is a flowchart of a method according to some embodiments of the present invention;

FIG. 9A is a flowchart of a method according to some embodiments of the present invention;

FIG. 9B is a flowchart of a method according to some embodiments of the present invention;

FIG. 10 is a flowchart of a method according to some embodiments of the present invention;

FIG. 11A depicts an example user interface according to some embodiments of the present invention; and

FIG. 11B depicts an example user interface according to some embodiments of the present invention.

### DETAILED DESCRIPTION

### A. Introduction

Applicants have recognized that, in accordance with some embodiments described in this disclosure, insurance providers, medical care providers, claim professionals and others assessing the expected costs of medical treatment (e.g., in relation to an insurance claim) may find it beneficial to have available a single concise source for acquiring information on the medical diagnostics, treatments and related costs for injuries on which claims are most commonly filed. Such a source may eliminate, in many instances, the necessity of having claim professionals independently select, consult with and cross-reference among multiple, disparate sources of information available. Accordingly, some embodiments may improve the accuracy, consistency and reliability of such cost assessments.

Applicants have recognized that some companies and personnel (e.g., claim professionals) assessing the expected costs of providing medical care (e.g., for a bodily injury that is the subject of a claim) may find it beneficial, in accordance with some embodiments, (i) to establish benchmarks more easily for the nature, extent and total cost of medical care based on medical treatment guidelines; (ii) to provide for more accurate case management by having reasonable diagnosis, treatment and related costs outlined or otherwise represented more clearly; and/or (iii) to establish a more realistic picture of the damages related to a claim through a clearer understanding of the reasonable and necessary treatments for an alleged injury.

Some embodiments described in this disclosure provide for the aggregation, analysis and preparation of data (e.g., historical claim and/or patient data) for use in assessing medical costs and, where applicable, projecting appropriate reserve amounts for claims.

Applicants have recognized that it may be beneficial, in accordance with some embodiments, to create and/or access available data stores of sufficient detail that a claim professional entering minimal information regarding a claim (e.g., a category of a bodily injury, a geographic region, age and one or more relevant comorbidities of a patient or claimant) may be presented with detailed information about expected total costs of the medical care for the claim.

Applicants have recognized that it would be desirable, in accordance with some embodiments, to provide a user interface for assessing medical costs of claims. In one embodiment, the user interface allows for receiving information (e.g., from a claim professional or other user) for determining the expected components of medical care, the respective expected costs and respective quantities. Alternatively or in addition, the determined information may be presented to the user via the interface (e.g., by displaying or otherwise communicating the components, their prices and their associated quantities to the user).

Applicants have also recognized that those assessing the expected costs of providing medical care may find it beneficial, in accordance with some embodiments, to project and total the respective costs of various components of medical care, including, by way of example and not limitation: medical diagnostics, treatment, prescription drugs, other medications and durable medical equipment.

In accordance with some embodiments, systems, apparatus, methods and articles of manufacture provide for projecting costs of medical care based on one or more sources of pricing information, including but not limited to (i) medical fee schedule pricing information, (ii) Usual and Customary Rate pricing information, (iii) Medicare pricing information and (iv) historical information based on amounts actually paid in the past (e.g., as may have been paid by an insurance carrier for a given type of injury). Some embodiments allow for convenient comparison of costs projected (e.g., for a particular type of injury) using two or more different pricing schemes or sources of available pricing information, and/or allowing a user to select from among a plurality of pricing schemes.

In some embodiments, pricing information for a procedure or other component of medical care may be selected or otherwise determined based on a variety of factors, including but not limited to: a type of injury, an insurance line of business or product (e.g., auto liability, general liability, workers compensation) and/or a geographic region (e.g., a postal ZIP code, a city, a state, a county, a province, a country) associated with a venue of treatment, an injured person, an insurance carrier, a claimant and/or a medical care provider.

In accordance with some embodiments, systems, apparatus, methods and articles of manufacture provide for determining one or more diagnostic and/or treatment procedures associated with a medical condition (e.g., a musculoskeletal injury) and determining, for each procedure, an expected number of the procedure (e.g., two X-rays) required to treat the medical condition. Some embodiments provide for making such determinations for each of a plurality of medical conditions (e.g., the fifty most frequently occurring musculoskeletal injuries).

Some embodiments provide for storing each procedure in association with a medical condition and with the expected number of that procedure in treating the medical condition. In accordance with some embodiments, an indication of a diagnosed medical condition (e.g., an injury type) is stored (e.g., in one or more databases) in association with at least one procedure (for diagnosis and for treatment) for treating the medical condition, and an indication of each associated procedure is stored (e.g., in one or more databases) in association with an expected number of that procedure for treating that medical condition. For example, a record of a database may store an indication of (i) a medical condition (e.g., a finger injury), (ii) a procedure expected in treating the condition (e.g., an X-ray) and (iii) an expected number of the procedure expected in treating the medical condition (e.g., four X-rays). Some additional embodiments provide for repeating such storage of information for each of a plurality of medical conditions.

In accordance with some embodiments, systems, apparatus, methods and articles of manufacture provide for (i) determining one or more diagnosis codes (e.g., ICD-9 codes) relevant to a particular injury type or other medical condition; (ii) mapping, “cross-walking” or otherwise associating one or more corresponding diagnostic and treatment procedures to each respective diagnosis code (e.g., by associating one or more appropriate CPT codes with each ICD-9 diagnosis code assigned to an injury), thereby establishing a set of one or more procedures for each medical condition; and (iii) determining, for each associated diagnostic and treatment procedure, an expected number of that procedure that will be necessary to treat the medical condition (e.g., based on standard medical treatment guidelines and/or historical claim data).

In accordance with some embodiments, systems, apparatus, methods and articles of manufacture provide for (i) determining or selecting a procedure for treating and/or diagnosing a person's medical condition (e.g., physical therapy for an injured foot) and (ii) determining an expected number of occurrences of the procedure in treating the person's medical condition based on an age of the person and/or at least one comorbidity condition associated with the person. In one embodiment, the expected number of occurrences may be based on a multiplier corresponding to one or more comorbidities, but not to an age factor; in another embodiment, the expected number of occurrences may be based on a multiplier corresponding to age, but not to any comorbidity factors. In some embodiments, an age coefficient may be used only if there are no comorbidity conditions, if there are less than a predetermined number of comorbidity conditions or if one or more particular predetermined comorbidity conditions (e.g., obesity) are not present.

The expected number of occurrences of the procedure may be used, for example, in calculating a total cost of providing the procedure and/or calculating a total expected medical cost of a claim (e.g., based on a plurality of expected procedures). In one embodiment, determining the expected number of occurrences may comprise determining a first (base) expected number of occurrences of a procedure (e.g., accessing a database to determine that four physical therapy sessions are expected in treating an injured foot) and then modifying the first expected number to derive a second expected number (e.g., by multiplying the first expected number by one or more coefficients corresponding to factors such as age and/or comorbidity).

In accordance with some embodiments, systems, apparatus, methods and articles of manufacture provide for projecting an expected cost for treating a person's injury based on one or more factors associated with the person, including but not limited to: an age of the person, at least one comorbidity condition of the person, the person's gender, the person's occupation, the person's geographic region, the person's DNA, the person's current health status, the person's medical history and/or one or more genetic markers of the person. In one embodiment, determining the expected cost may comprise determining a first (base) expected cost of at least one medical procedure and then modifying the first expected cost to derive a second expected cost (e.g., by multiplying the first expected cost by one or more coefficients corresponding to factors such as age, gender and/or comorbidity). In another embodiment, determining the expected cost may comprise determining a first (base) expected number of units of at least one medical procedure and then deriving a second expected number of units (e.g., by the multiplying the first expected number of units by one or more coefficients).

In accordance with some embodiments, systems, apparatus, methods and articles of manufacture provide for (i) determining or selecting a procedure for treating and/or diagnosing a person's medical condition (e.g., physical therapy for an injured foot) and (ii) determining an expected cost of the procedure for treating the person's medical condition based on an age of the person and/or at least one comorbidity associated with the person. In one embodiment, determining the expected cost may comprise determining a first (base) expected cost of a procedure (e.g., accessing a database to determine that physical therapy for treating a whiplash injury costs, on average, $88.00 per session) and then modifying the first expected cost to derive a second expected cost (e.g., by multiplying the first expected cost by one or more coefficients corresponding to factors such as age and/or comorbidity).

In accordance with some embodiments, an expected cost for a particular procedure may be based on and/or selected using (e.g., from a database of pricing information) one or more of: an insurance line of business (e.g., auto liability, general liability, workers compensation), a geographic region, historical cost data, a fee schedule (e.g., a WC fee schedule), UCR pricing information (e.g., 90% of UCR) and/or Medicare pricing information.

### B. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting.

Acronyms

| | |
|---|---|
| ICD-9 | International Classification of Diseases, Ninth Revision |
| CPT | Current Procedure Terminology |
| ACOEM | American College of Occupational and Environmental Medicine |
| UCR | Usual and Customary Reimbursement Fees/Usual, Customary |
| | and Reasonable Fees |
| WC | Workers Compensation |
| DME | Durable Medical Equipment |

The term “medical care component”, as used herein, may comprise one or more medical procedures (e.g., diagnostic procedures, treatment procedures), prescriptions, medications, DME and/or other component of medical treatment (e.g., for a bodily injury).

The term “medical procedure”, as used herein, may include one or more of various procedures such as are contemplated, for example, under medical treatment guidelines (e.g., ACOEM guidelines) and/or procedure classification systems such as CPT.

Some embodiments are associated with a “coefficient” or a “multiplier”. As used herein, the terms “coefficient” and “multiplier” may be used interchangeably and may refer to any stored or derived value that may be used to modify or multiply a base or initial value. In one example, an age coefficient based on an age of an injured person may be multiplied by a base number of expected units of a treatment procedure, or by a base expected total cost of a treatment procedure, to determine a final expected total cost for the type of procedure. In some embodiments, the term “health multiplier” may be used to refer to an age coefficient, a comorbidity coefficient and/or a product of one or more age coefficients and one or more comorbidity coefficients (e.g., in which the product may be used as a multiplier of a base or initial value). A multiplier may include, in some embodiments, values less than, equal to, and/or greater than 1.00. For example, in some embodiments an appropriate multiplier or coefficient for a desired baseline patient population (e.g., patients under 40 years of age, patients with no comorbidity conditions) may be set at 1.00. Accordingly, applying a multiplier may comprise multiplying by 1.00, or, in some embodiments, not multiplying by the multiplier if the value is exactly 1.00 (e.g., using a first or base value as a second or final value, such as a number of expected units or total cost).

Some embodiments are associated with a “factor” and/or “consideration”, such as an age factor, age consideration, gender factor, comorbidity factor or comorbidity consideration. The terms “factor” and “consideration”, where modified by an adjective such as age or comorbidity, may be used interchangeably and may refer to a description of such factor (e.g., a comorbidity condition of obesity) and/or to a value of such factor (e.g., an age factor may comprise an age multiplier value of 1.23).

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

### C. Exemplary Embodiments

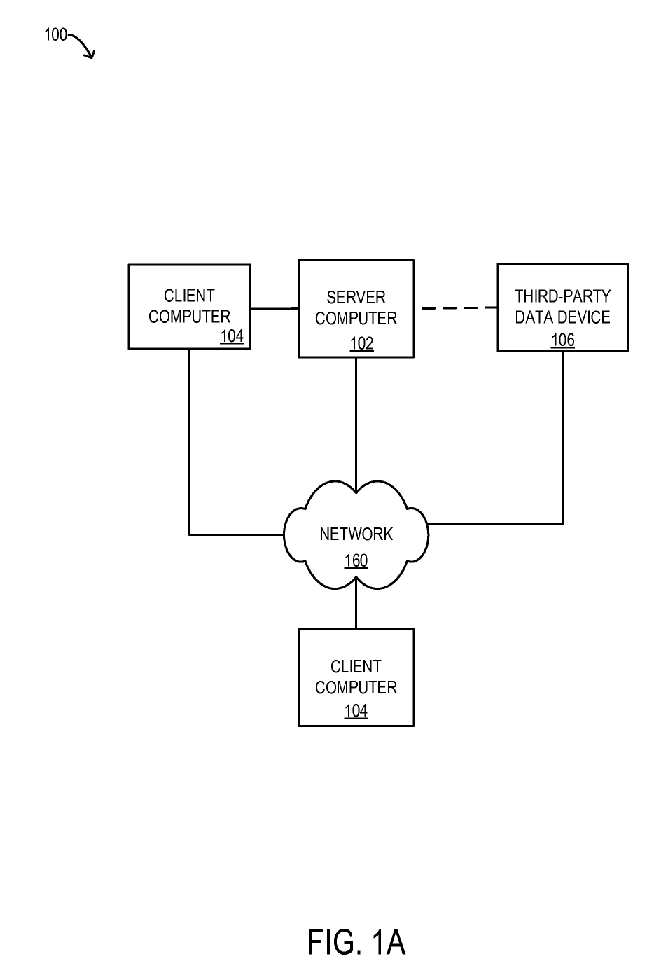

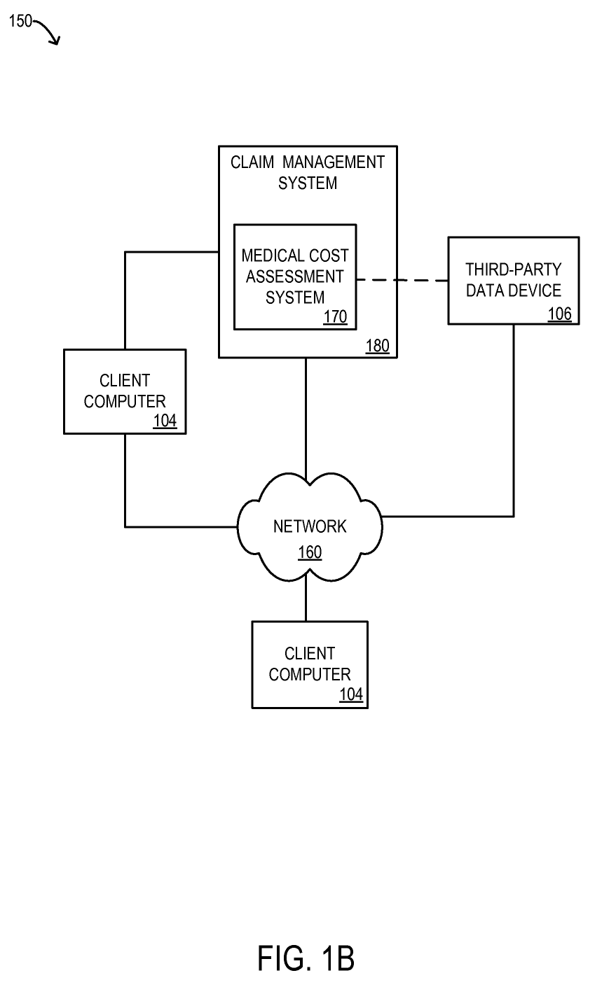

FIG. 1A depicts a block diagram of an example system 100 according to some embodiments. The system 100 may comprise one or more client computers 104 in communication with a controller or server computer 102 via a network 160. Typically a processor (e.g., one or more microprocessors, one or more microcontrollers, one or more digital signal processors) of a client computer 104 or server computer 102 will receive instructions (e.g., from a memory or like device), and execute those instructions, thereby performing one or more processes defined by those instructions. Instructions may be embodied in, e.g., one or more computer programs and/or one or more scripts.

In some embodiments a server computer 102 and/or one or more of the client computers 104 stores and/or has access to data associated with one or more individuals and useful for assessing medical care costs. Such information may include one or more of: (i) historical claim data (e.g., actual costs paid for past medical injury claims), (ii) medical care component information (e.g., recommended treatment procedures, prescription information, DME information), (iii) age coefficients and (iv) comorbidity coefficients. In one example, historical claim data, age coefficients and/or comorbidity coefficients may be specific to one individual (e.g., an injured worker). In another example, such information may be associated with more than one person, claimant, company, insured, state and/or other useful population, as desired for a particular implementation.

According to some embodiments, any or all of such data may be stored by or provided via one or more optional third-party data devices 106 of system 100. A third-party data device 106 may comprise, for example, an external hard drive or flash drive connected to a server computer 102, a remote third-party computer system for storing and serving data for use in projecting medical costs, or a combination of such remote and local data devices. A third-party entity (e.g., a party other than an owner and/or operator, etc., of the server computer 102, client computer 104 and other than an end-user of any data used in medical cost assessment) may comprise, without limitation, (i) a third-party vendor collecting data on behalf of the owner, a marketing firm, government agency and/or regulatory body, and/or (ii) a demographic data gathering and/or processing firm. A third-party entity, such as a pharmacy, health care provider or retailer may, for example, collect and/or monitor patient, customer, sales and/or claim data for various purposes deemed useful by the third party, including, without limitation, data mining, data analysis, data aggregation, price tracking and/or sale or exchange of collected data. In one embodiment, any raw data, data analysis and/or metrics may be stored on and/or made available (e.g., to an insurer) via the third-party data device 106. In one embodiment, one or more companies and/or end users may subscribe to or otherwise purchase data (e.g., medical care component data and/or coefficient data) from a third party and receive the data via the third-party data device 106.

In some embodiments, health risk assessment (HRA) tools may facilitate the collection of health data for one or more individuals. For example, HRA tools such as kiosk-based diagnostic or data entry systems, web-based programs and applications, paper mailings, email communications, telephonic surveys and/or other types of information collection may allow for users to self report health data. Accordingly, in some embodiments, third-party sources of HRA surveys, such as by government and/or commercial health care insurers and researchers, could be stored on, received from and/or made accessible via third-party device(s) 106.

In some embodiments, a client computer 104, such as a computer workstation or terminal of a claim professional of an insurance company, is used to execute a medical cost assessment application, stored locally on the client computer 104, that accesses information stored on, or provided via, the server computer 102. In another embodiment, the server computer 102 may store some or all of the program instructions for assessing medical costs, and the client computer 104 may execute the application remotely via the network 160 and/or download from the server computer 102 (e.g., a web server) some or all of the program code for executing one or more of the various functions described in this disclosure.

In one embodiment, a server computer may not be necessary or desirable. For example, some embodiments described in this disclosure may be practiced on one or more devices without a central authority. In such an embodiment, any functions described herein as performed by a server computer and/or data described as stored on a server computer may instead be performed by or stored on one or more such devices. Additional ways of distributing information and program instructions among one or more client computers 104 and/or server computers 102 will be readily understood by one skilled in the art upon contemplation of the present disclosure.

FIG. 1B depicts a block diagram of another example system 150 according to some embodiments. The system 150 may comprise one or more client computers 104 in communication with a claim management system 180 (such as may be hosted by, for example, a server computer 102) via a network 160. A medical cost assessment system 170 is integrated into the central claim processing system 180, for example, as a module or other functionality accessible through the claim management system 180. In one embodiment, information about a particular claim and stored by the claim management system 180 may be provided advantageously to the medical cost assessment system 170. For example, stored information about an injured claimant, such as age and state of residence, may be accessible by the medical cost assessment system 170 without requiring manual input by a claim professional. As discussed above with respect to system 100 of FIG. 1A, in some embodiments one or more third-party data devices 106 may store information (e.g., medical procedure cost information) used in assessing medical costs of a claimed injury.

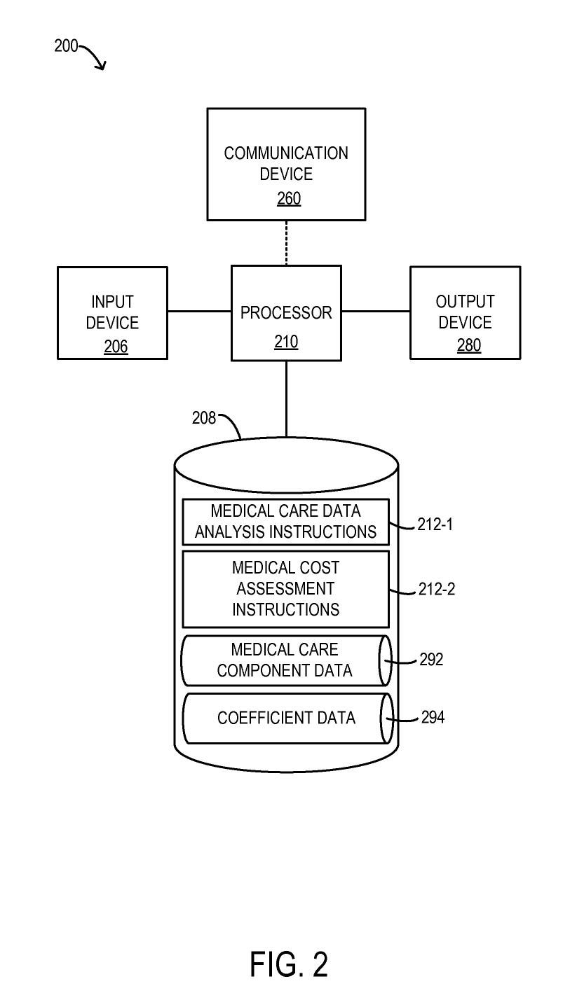

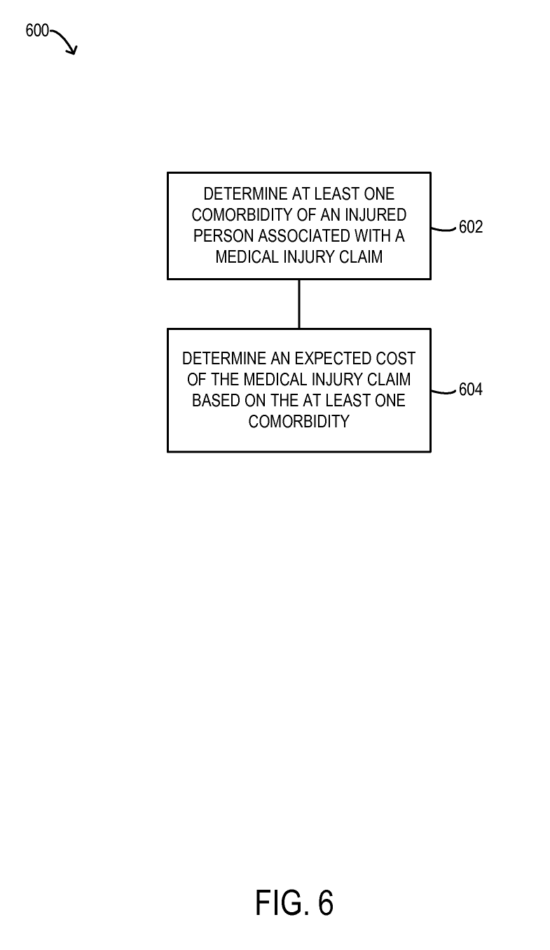

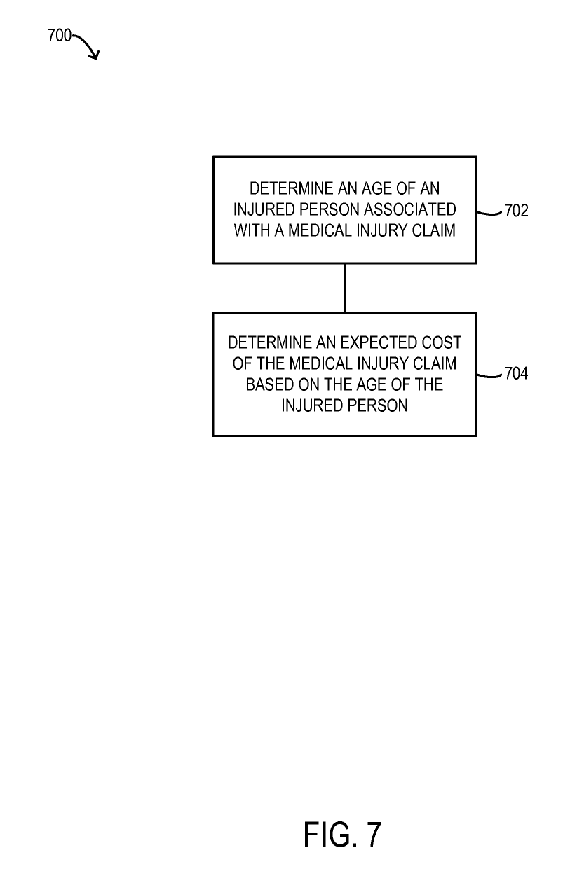

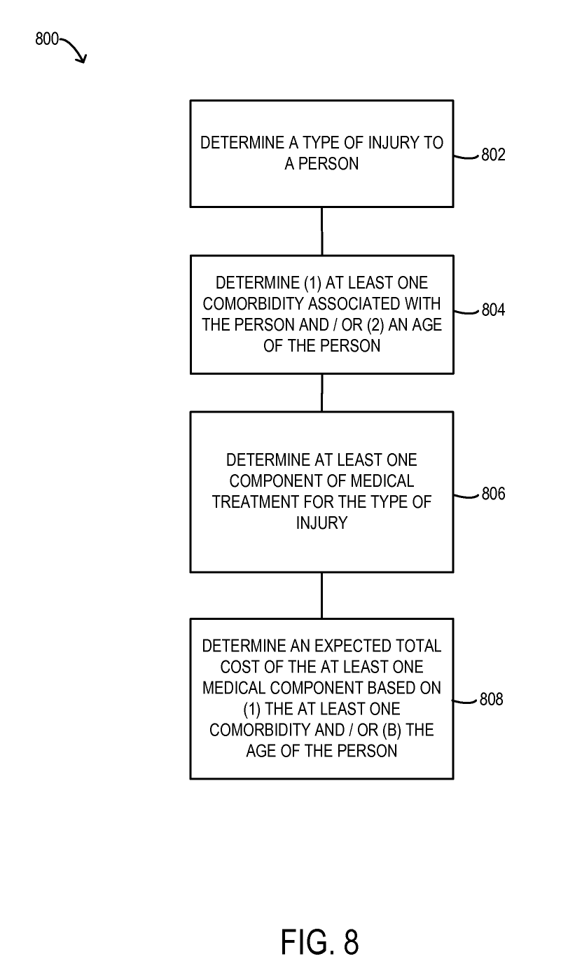

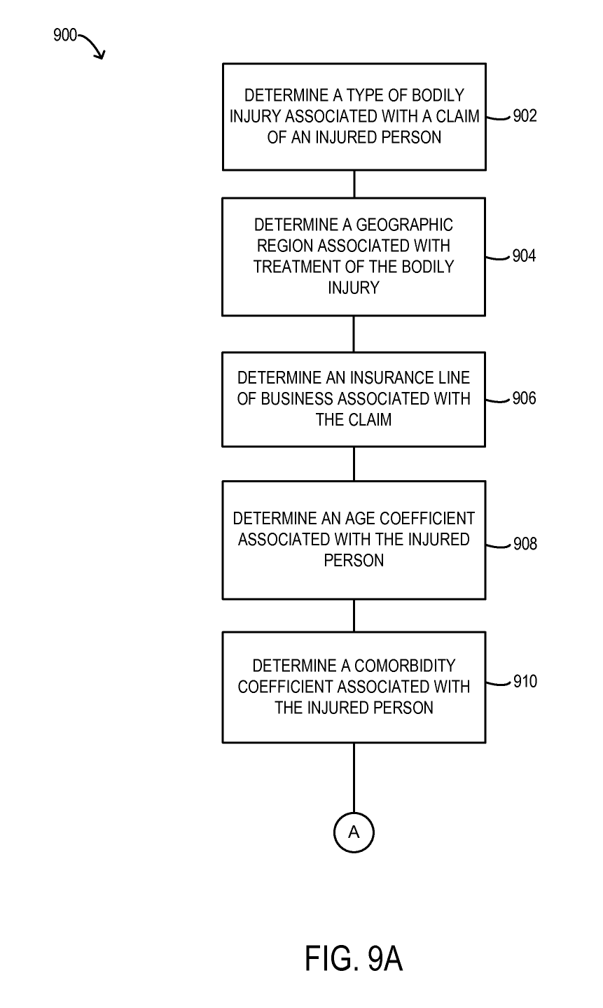

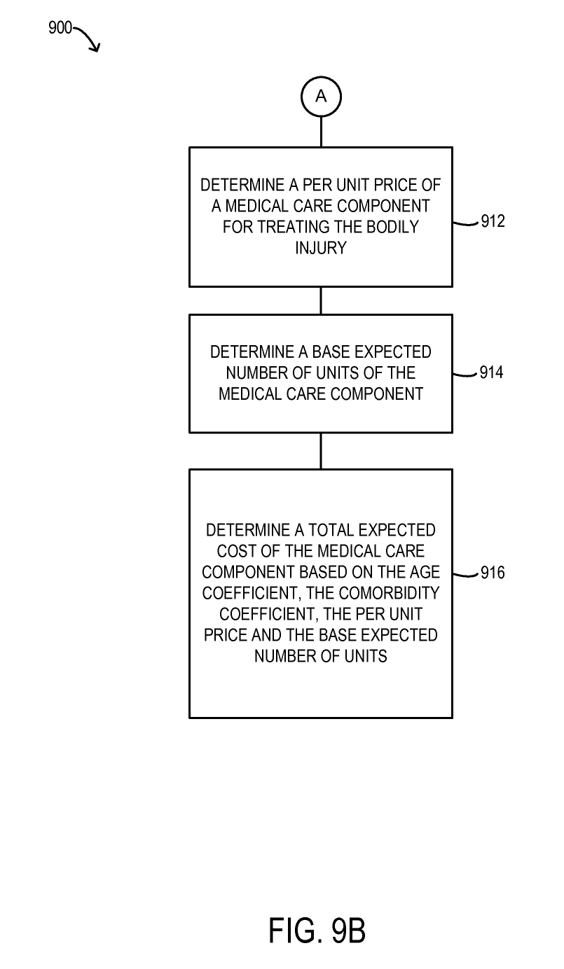

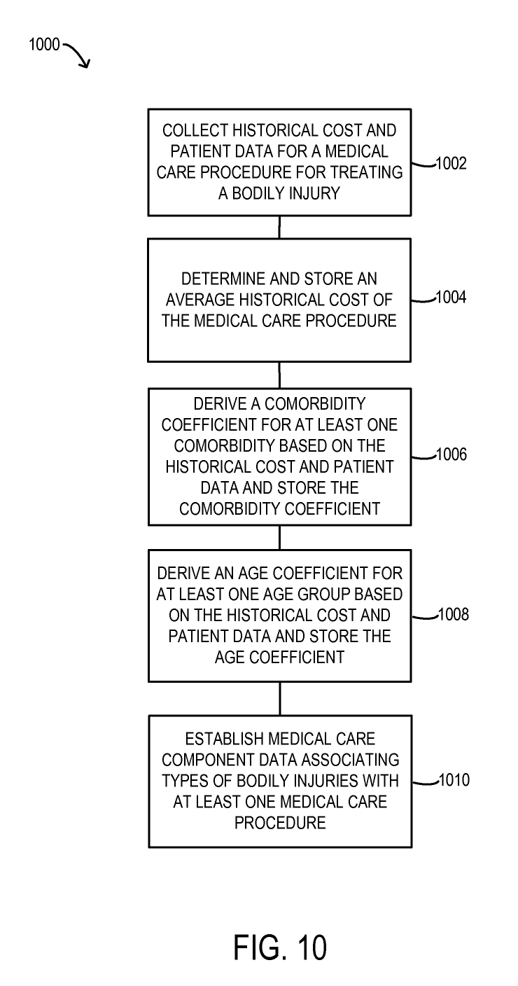

Turning to FIG. 2, a block diagram of an apparatus 200 according to some embodiments is shown. In some embodiments, the apparatus 200 may be similar in configuration and/or functionality to any of the client computers 104, server computers 102, third-party data devices 106 and/or claim management system 180 of FIG. 1A and/or FIG. 1B. The apparatus 200 may, for example, execute, process, facilitate, and/or otherwise be associated with any of the processes 600, 700, 800, 900, 1000 described in conjunction with FIG. 6, FIG. 7, FIG. 8, FIG. 9A, FIG. 9B and FIG. 10 herein.

In some embodiments, the apparatus 200 may comprise an input device 206, a memory device 208, a processor 210, a communication device 260, and/or an output device 280. Fewer or more components and/or various configurations of the components 206, 208, 210, 260, 280 may be included in the apparatus 200 without deviating from the scope of embodiments described herein.

According to some embodiments, the processor 210 may be or include any type, quantity, and/or configuration of processor that is or becomes known. The processor 210 may comprise, for example, an Intel® IXP 2800 network processor or an Intel® XEON™ Processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 900 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a keyboard that allows an operator of the apparatus 200 to interface with the apparatus 200 (e.g., by a claim professional, such as to assess recommended medical procedures and associated expected costs for an injury claim). In some embodiments, the input device 206 may comprise a sensor configured to provide information such as encoded claim or claimant information to the apparatus 200 and/or the processor 210.

The output device 280 may, according to some embodiments, comprise a display screen and/or other practicable output component and/or device. The output device 280 may, for example, provide medical cost analysis to an insurance claim professional or medical care provider professional seeking to project the costs of providing medical care to a claimant/patient (e.g., via a computer workstation). According to some embodiments, the input device 206 and/or the output device 280 may comprise and/or be embodied in a single device such as a touch-screen monitor.

In some embodiments, the communication device 260 may comprise any type or configuration of communication device that is or becomes known or practicable. The communication device 260 may, for example, comprise a network interface card (NIC), a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals (e.g., claim information, requests for medical procedure pricing data) to a server in communication with a plurality of handheld, mobile and/or telephone devices. According to some embodiments, the communication device 260 may also or alternatively be coupled to the processor 210. In some embodiments, the communication device 260 may comprise an IR, RF, Bluetooth™, and/or Wi-Fi® network device coupled to facilitate communications between the processor 210 and another device (such as one or more client computers, server computers, central controllers and/or third-party data devices).

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

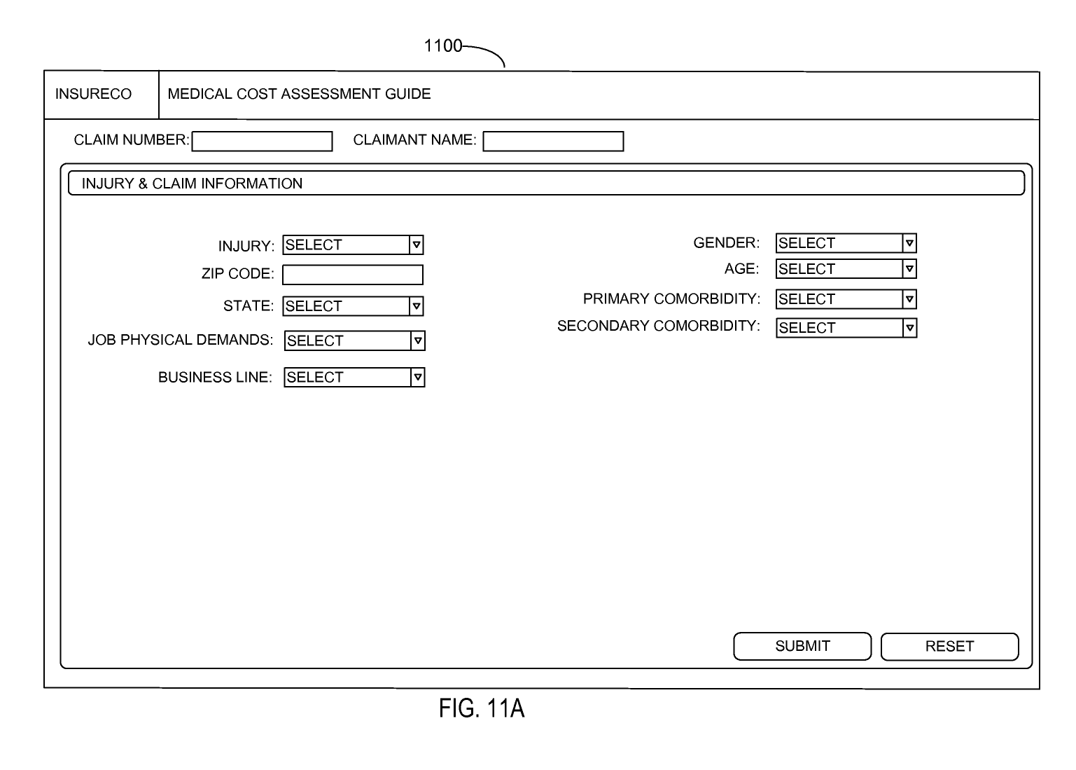

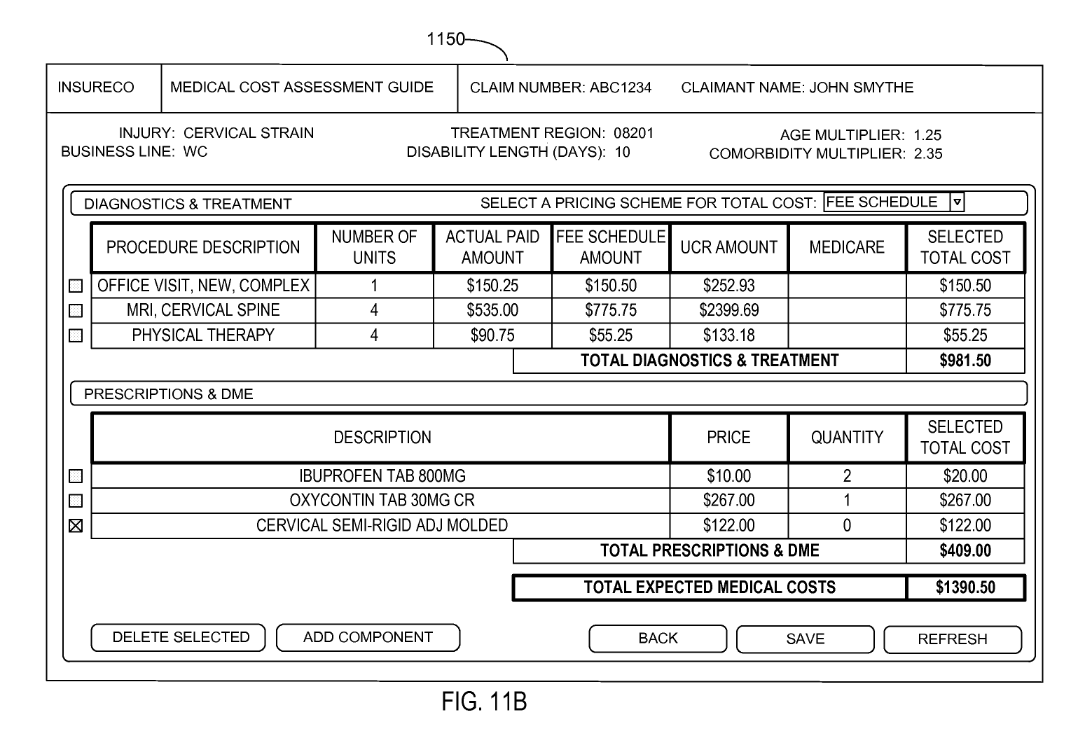

The memory device 208 may, according to some embodiments, store one or more of medical care data analysis instructions 212-1, medical cost assessment instructions 212-2, medical care component data 292 and/or coefficient data 294. In some embodiments, the medical care data analysis instructions 212-1 and/or medical cost assessment instructions 212-2 may be utilized by the processor 210 to provide output information via the output device 280 and/or the communication device 260 (e.g., via the user interfaces 1100 and/or 1150 of FIG. 11A and FIG. 11B, respectively).

According to some embodiments, medical care data analysis instructions 212-1 may be operable to cause the processor 210 to process medical care component data 292 as described herein. Medical care component data 292 received via the input device 206 and/or the communication device 260 may, for example, be data mined, analyzed, sorted, filtered, decoded, decompressed, ranked, scored, plotted, and/or otherwise processed by the processor 210 in accordance with the instructions of medical care data analysis instructions 212-1 (e.g., in accordance with the method 1000 of FIG. 10). In some embodiments, historical claim and/or medical care pricing information may be fed by the processor 210 through one or more mathematical and/or statistical equations and/or models in accordance with instructions of medical care data analysis instructions 212-1 to define one or more coefficients (e.g., described by the coefficient data 294) that may then be utilized for various purposes as described herein.

According to some embodiments, the medical cost assessment instructions 212-2 may be operable to cause the processor 210 to perform a medical cost assessment (e.g., for a claimed injury) as described herein. Medical care component data 292 and/or coefficient data 294 may be analyzed to generate listings of recommended medical care components (e.g., procedures, prescriptions) and/or medical cost projections, for example, that may be utilized to assess a total expected cost (and/or reserve amount) for a claim of an alleged injury (e.g., in accordance with the method 800 of FIG. 8). The medical cost assessment instructions 212-2 may, in some embodiments, utilize the coefficient data 294 to revise base expected numbers of a given procedure stored as part of the medical care component data 292 and/or to revise expected total costs for a given procedure.

The apparatus 200 may function as a computer terminal and/or server of an insurance and/or medical care provider, for example, that is utilized to process insurance claims or assess costs of providing medical care. In some embodiments, the apparatus 200 may comprise a web server and/or other portal (e.g., an IVRU) that provides medical care component data 292 and/or coefficient data 294 to users, consumers and/or corporations.

Any or all of the exemplary instructions and data types described herein and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 (e.g., as shown) or may simply be accessible to the apparatus 200 (e.g., externally located and/or situated).

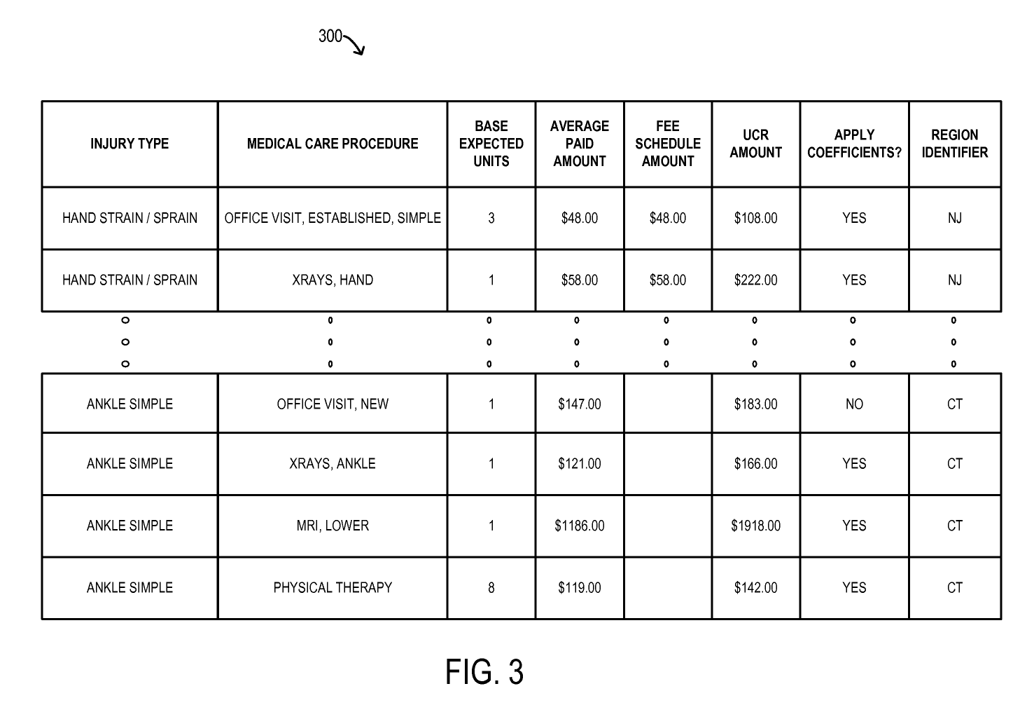

Referring to FIG. 3, a schematic illustration of an exemplary data structure 300 according to some embodiments is shown. In some embodiments, the exemplary data structure 300 may comprise a tabular representation illustrating an embodiment of the medical care component data 292. The exemplary data structure 300 that is representative of the medical care component data 292 includes a number of example records or entries, each of which defines a medical care component for a particular injury type and region identifier. Those skilled in the art will understand that the medical care component data 292 may include any number of entries. The exemplary data structure 300 of the medical care component data 292 also defines fields for each of the entries or records, including: (i) an injury type field, (ii) a medical care procedure field, (iii) a base expected units field, (iv) an average paid amount field, (v) a fee schedule amount field, (vi) a UCR amount field, (vii) an apply coefficients field and (viii) a region identifier field.

In one or more embodiments, the injury type field allows for entry and storage of a plurality of injury type identifiers corresponding to respective categories of injuries (e.g., bodily injuries). Similarly, the medical care procedure field allows for entry and storage of a plurality of medical care procedure identifiers corresponding to respective types of treatment or diagnostic procedures appropriate or recommended for the corresponding type of injury. Although the identifiers provided in the example data structure 300 are text descriptions, it will be understood that such identifiers could be any alphanumeric or other type of identifier that uniquely identifies a particular type of injury or medical care procedure.

In one or more embodiments, the region identifier field allows for entry and storage of one or more identifiers uniquely identifying a geographic region (e.g., a postal ZIP code, a carrier locality, a city, a state, a county, a province, a country). In some embodiments, the region identifier identifies the region for which the corresponding base expected number of units and the corresponding one or more price amounts associated with the procedure are recommended. In one example, example data structure 300 depicts different costs for providing a hand X-ray for a hand strain in New Jersey according to different pricing schemes (e.g., $58.00, $58.00 and $222.00), and one hand X-ray is recommended (the base expected number of X-rays for treating that injury in New Jersey).

In one or more embodiments, the base expected units field allows for entry and storage of a number of the corresponding procedure (or other component) recommended for the corresponding bodily injury (and/or for the corresponding region). In one example, one hand X-ray is recommended in treating a hand strain in New Jersey. As described herein, the number of base expected units may be used in calculating an expected number of units of a procedure where, for example, one or more coefficients related to a patient's age and/or comorbidity condition(s) are to be applied. The apply coefficients field allows for entry and storage of an indication of whether factors such as an injured person's age and/or comorbidity conditions should be considered in determining a total expected number of units of a given procedure or other component and/or determining a total expected cost of a given procedure (e.g., covering all expected units of that procedure). In one embodiment, separate respective indications of whether or not to apply a multiplier may be stored for each of a plurality of multipliers.

In one or more embodiments, example data structure 300 provides for one or more different prices and/or different recommended pricing schemes for a corresponding procedure for treating a corresponding injury in the corresponding region. It will be readily understood that any type or number of pricing information or pricing schemes may be stored (e.g., in association with a particular bodily injury, region and procedure) and used in assessing the expected costs of medical care. In one example, associated prices for providing treatment may be based on: historical amounts actually paid out (e.g., for a medical injury claim) for that procedure in the corresponding region in the past (e.g., during the past year), a fee schedule amount for that procedure (e.g., as may be established by state, local or national regulations, a Medicare fee schedule, a medical care provider and/or an insurance carrier) and an amount based on a UCR rate (e.g., 90% of a UCR rate for a given procedure). The storage or ready availability of a plurality of costs associated with different pricing schemes and/or based on different sources allows advantageously, in accordance with some embodiments, for displaying or otherwise representing to a user (e.g., a claim professional) two or more prices for the same procedure. For example, a user interface displaying two costs in proximity to one another (e.g., on the same display screen) may allow for easy comparison of the different costs and/or implications of selecting one pricing scheme over another.

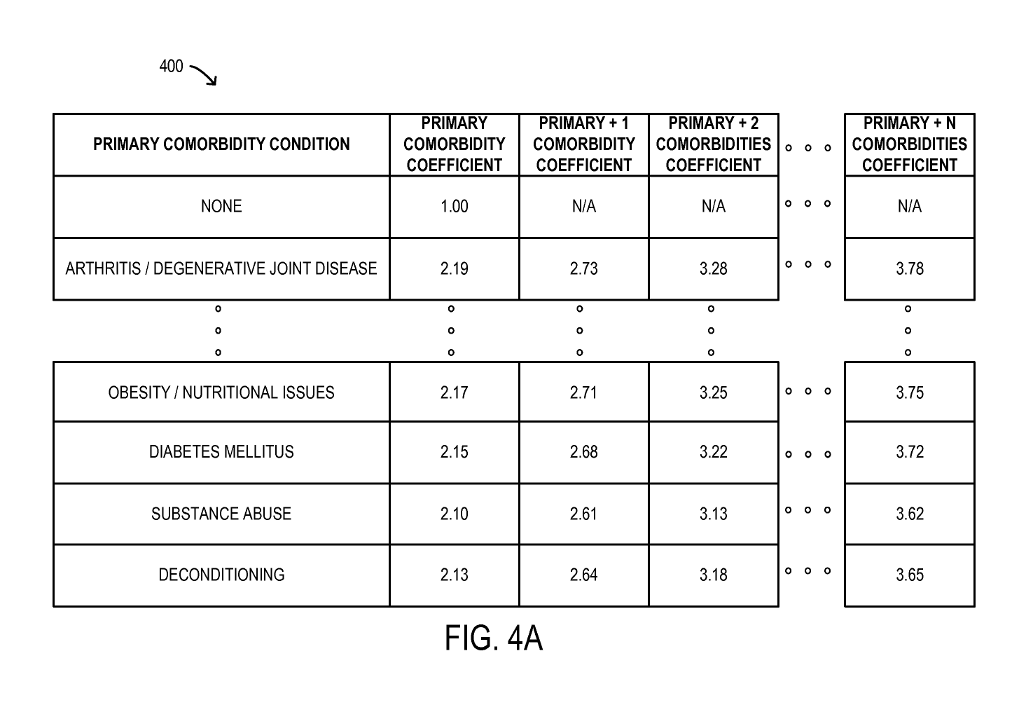

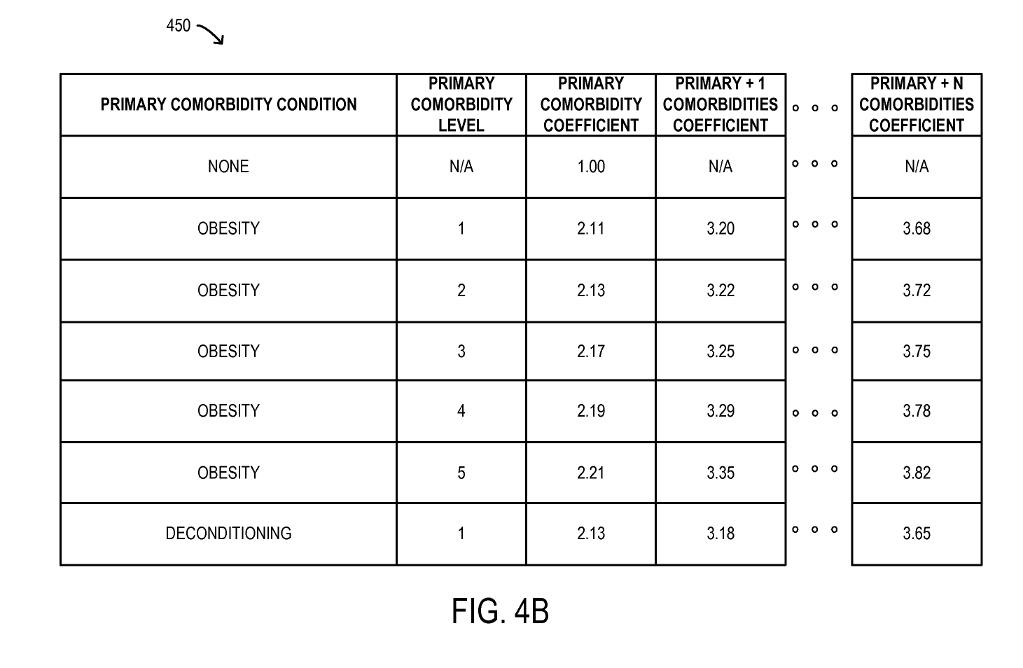

Referring to FIG. 4A, a schematic illustration of an exemplary data structure 400 according to some embodiments is shown. In some embodiments, the exemplary data structure 400 may comprise a tabular representation illustrating an embodiment of the coefficients data 294. The exemplary data structure 400 that is representative of the coefficients data 294 includes a number of example records or entries, each of which defines coefficients corresponding to a particular primary comorbidity condition. Those skilled in the art will understand that the coefficient data 294 may include any number of entries. The exemplary data structure 400 of the coefficient data 294 also defines fields for each of the entries or records, including: (i) a primary comorbidity condition field, (ii) a primary comorbidity coefficient field, (iii) a primary+1 comorbidity coefficient field, (iv) a primary+2 comorbidities coefficient field and (v) a primary+n comorbidities coefficient field.

In one or more embodiments, the primary comorbidity condition field allows for entry and storage of a plurality of comorbidity condition identifiers corresponding to respective comorbidity conditions. Although the identifiers provided in the example data structure 400 are text descriptions, it will be understood that such identifiers could be any alphanumeric or other type of identifier that uniquely identifies a particular comorbidity condition.

Those skilled in the art will recognize that “comorbid” conditions or “comorbidity” conditions are conditions existing in a patient simultaneously with, but usually unrelated to or independent of, another identified medical condition, such as a pathological or disease process or injury. Comorbidity conditions may include, without limitation, one or more of the following:
Arthritis/Degenerative Joint Disease
Obesity/Nutritional Issues
Osteoporosis/penia
Diabetes Mellitus
Alcoholism
Substance Abuse
Deconditioning
Chronic Steroid Use
Immune Deficiency
Smoker
Autoimmune disorder
Chronic Obstructive Pulmonary Disease
Cardiovascular
Renal
   Applicants have recognized that the medical costs associated with treatment of a bodily or musculoskeletal injury may be correlated significantly to the presence of one or more comorbidity conditions. Applicants have further recognized that a plurality of comorbidity conditions may have a cumulative effect on the cost of medical care. Some embodiments described in this disclosure provide for determining an expected medical cost of a claim based on one or more comorbidity conditions, considerations or coefficients.

In one or more embodiments, the primary comorbidity coefficient field allows for entry and storage of a coefficient determined for a corresponding primary comorbidity condition (e.g., determined in accordance with one or more steps of the process 1000 of FIG. 10). In one or more embodiments, the primary+1 comorbidity coefficient, primary+2 comorbidities coefficient and/or primary+n comorbidities coefficient fields allow for entry and storage of coefficients determined for the presence of a corresponding primary comorbidity condition and at least one other comorbidity condition. A coefficient may be applied, as discussed with respect to various described embodiments, by multiplying a base number of expected units of a procedure to treat an injury (e.g., as may stored in medical care component data 292) by the coefficient to derive a number of expected units of a procedure (e.g., office visits, acupuncture sessions, physical therapy sessions, ambulance transportation). Application of the multiplier, in some embodiments, thus allows for an assessment of projected medical costs for a medical care procedure that takes into account additional expected units of treatment (or other additional costs related to a particular treatment) that may be necessary because of at least one comorbidity condition. For example, a person having one or more comorbidities and/or a higher age may require additional physical therapy sessions to recover from an injury than a person having no comorbidities and/or a lower age.

Referring to FIG. 4B, a schematic illustration of an exemplary data structure 450 according to some embodiments is shown. In some embodiments, the exemplary data structure 450 may comprise a tabular representation illustrating an embodiment of the coefficients data 294. The exemplary data structure 450 that is representative of the coefficients data 294 includes a number of example records or entries, each of which defines coefficients corresponding to a particular degree, level or other relative gradation of a primary comorbidity condition. Those skilled in the art will understand that the coefficient data 294 may include any number of entries. The exemplary data structure 450 of the coefficient data 294 also defines fields for each of the entries or records, including: (i) a primary comorbidity condition level field, (ii) a primary comorbidity coefficient field, (iii) a primary+1 comorbidity coefficient field and (iv) a primary+n comorbidities coefficient field.

As discussed in this disclosure, a determination of the existence of a comorbidity condition, such as obesity, may be useful, in some embodiments, for projecting medical costs associated with a claim. More direct measurements of the health status of a particular individual, however, may allow for assessing a level, degree or other more precise measure of a condition that may be useful, in accordance with some embodiments, for improving the accuracy of assessing medical costs for that individual (and/or for one or more individuals having a similar health status). Such coefficients may allow for a more accurate prediction of medical service utilization, lost time days and/or intervention strategies. In one embodiment, health and other medical information specific to a particular individual (e.g., an injured worker) may be received from a third party (e.g., a health care provider) via a third-party device 106, received from the injured worker, and/or stored on server computer 102.

In one embodiment, more precise comorbidity coefficients may be determined based on a degree of the particular condition. In one example, physician providers, pharmacy clinics and physical therapy offices can measure height weight, and skin folds in order to determine body mass index (BMI), body adipose index (BAD, strength, range of motion and/or flexibility. Such direct measurements, for example, may allow for a measure of the degree of obesity or deconditioning for a particular individual. The degree of severity of obesity and musculoskeletal health may allow for new intervention strategies and more accurate assessments of potential medical costs associated with the individual. In one example, obesity coefficients may be developed based on a degree of being overweight or obesity.

Referring again to FIG. 4B, in one or more embodiments, the primary comorbidity level field allows for entry and storage of an identifier that identifies a relative level or degree of the associated primary comorbidity condition. For example, there are several example entries depicted for obesity, each corresponding to a different level of obesity (e.g., slightly overweight (level 1) to very obese (level 5)). The primary comorbidity coefficient field allows for entry and storage of a coefficient determined for a corresponding level of a primary comorbidity condition (e.g., determined in accordance with one or more steps of the process 1000 of FIG. 10). In one or more embodiments, the primary+1 comorbidity coefficient and/or primary+n comorbidity coefficient fields allow for entry and storage of coefficients determined for the presence of a corresponding level of the primary comorbidity condition and at least one other comorbidity condition. Application of the multiplier, in some embodiments, thus allows for an assessment of projected medical costs for a medical care procedure that takes into account expected units of treatment (or other costs related to a particular treatment) based on not only the mere existence of at least one comorbidity condition, but a degree or level of the associated condition(s).

Although the particular values of the coefficients described in FIG. 4A and FIG. 4B are equal to or greater than 1.00, it will be readily understood that such values may be less than 1.00, or may be any appropriate value for assessing the effect of one or more conditions on projected medical costs. In one embodiment, the appropriate factors (e.g., for use in applying to expected base costs) may be stored as percentages, ratios and/or other mathematical equivalents suitable for the desired implementation.

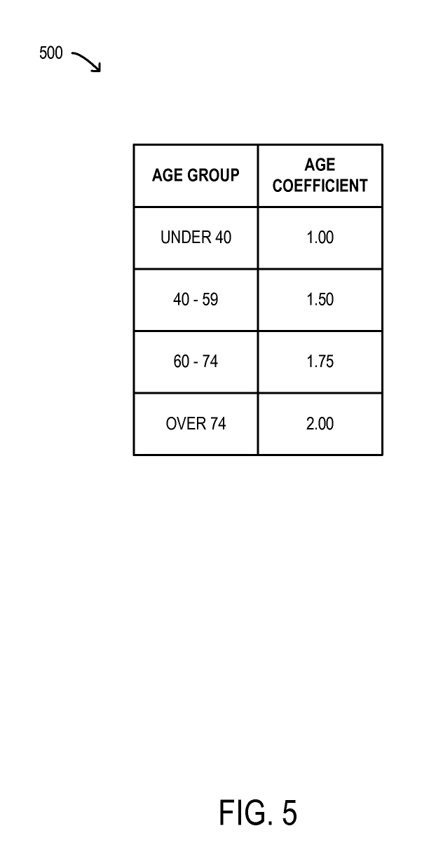

Referring to FIG. 5, a schematic illustration of an exemplary data structure 500 according to some embodiments is shown. In some embodiments, the exemplary data structure 500 may comprise a tabular representation illustrating an embodiment of the coefficients data 294. The exemplary data structure 500 that is representative of the coefficients data 294 includes a number of example records or entries, each of which defines coefficients corresponding to a particular age group. Those skilled in the art will understand that the coefficient data 294 may include any number of entries. The exemplary data structure 500 of the coefficient data 294 also defines fields for each of the entries or records, including: (i) an age group field and (ii) an age coefficient for the corresponding age group.

In one or more embodiments, the age group field allows for entry and storage of a plurality of age and/or age group identifiers corresponding to respective ages and/or age groups. It will be understood that such identifiers could be any alphanumeric or other type of identifier that uniquely identifies a particular age or group of ages (e.g., 6 to 18 months old, 37 years old, 45 to 49 years old).

Applicants have recognized that the medical costs associated with treatment of a bodily or musculoskeletal injury may be correlated significantly to the injured person's age. Some embodiments described in this disclosure provide for determining an expected medical cost of a claim based on an age, or age group, of an injured person.

In one or more embodiments, the age coefficient field allows for entry and storage of a coefficient determined for a corresponding age group (e.g., determined in accordance with step 1008 of the process 1000 of FIG. 10). An age group may include a specific age or a range of ages, as desirable for a particular implementation. A coefficient may be applied, as discussed with respect to various described embodiments, by multiplying a base number of expected units of a procedure to treat an injury by the coefficient to derive a number of expected units of a procedure (e.g., physical therapy sessions). Application of the multiplier, in some embodiments, thus allows for an assessment of projected medical costs for a medical care procedure that takes into account additional expected units of treatment (or other additional costs related to a particular treatment) that may be necessary because of a patient's age.

Although the particular values of the coefficients described in FIG. 5 are equal to or greater than 1.00, it will be readily understood that such values may be less than 1.00, or may be any appropriate value for assessing the effect of one or more conditions on projected medical costs. In one embodiment, the appropriate ages or age groups (e.g., for use in applying to expected base costs) may be stored as percentages, ratios and/or other mathematical equivalents suitable for the desired implementation.

Referring now to FIG. 6, a flow diagram of a method 600 according to some embodiments is shown. The method 600 may, for example, be performed by or on behalf of an insurer, a claim professional, a medical care facility and/or an insured person or other user. For purposes of brevity, the method 600 will be described herein as being performed by a computer (e.g., a client computer operated by a claim professional) on behalf of an insurance company. It should be noted that although some of the steps of method 600 may be described herein as being performed by a client computer while other steps are described herein as being performed by another computing device, any and all of the steps may be performed by a single computing device which may be a client computer, server computer, third-party data device or another computing device. Further any steps described herein as being performed by a particular computing device may be performed by a human or another computing device as appropriate.

According to some embodiments, the method 600 may comprise determining at least one comorbidity of an injured person associated with a medical injury claim, at 602. Determining at least one comorbidity may comprise one or more of: reviewing the injured person's medical history, accessing stored electronic data including information about the injured person's health; receiving an indication of at least one comorbidity via a user interface (e.g., from a claim professional or other user) or input device; and receiving a signal including an indication of the at least one comorbidity from a client computer, server computer, medical cost assessment system or third-party data device.

In one example of determining at least one comorbidity, a claim professional enters a primary comorbidity via a user interface (e.g., by selecting it from a dropdown menu of selectable comorbidities). In another example, a medical cost assessment application sends a request to a computer (e.g., a server computer) for any comorbidities associated with an injured person and the server returns an indication of associated comorbidities, if any. In yet another example, historical medical claim data is reviewed and/or analyzed and an indication of any comorbidity factors is stored (e.g., for analyzing the historical data set to derive comorbidity coefficients).

According to some embodiments, the method 600 may comprise determining an expected cost of the medical injury claim based on the at least one comorbidity, at 604. Determining the expected cost based on the at least one comorbidity may comprise (i) determining a first or base expected cost (e.g., a total or per unit cost) of a procedure and (ii) determining a second expected cost of the procedure (e.g., total or per unit cost) based on the first expected cost and a comorbidity coefficient associated with the at least one comorbidity. In one example, a base per unit cost of an X-ray procedure for a wrist injury is determined to be $58.00 (e.g., as identified by reference to medical care component data 292), and the base cost is multiplied by a comorbidity coefficient of 2.17 (e.g., corresponding to an obesity primary comorbidity condition associated with the injured person) to yield an expected per unit cost of $125.86 per X-ray. In another example, a first expected total cost for all of a base number of expected units may be multiplied by a comorbidity efficient to yield an expected total cost for all expected instances of that procedure.

Alternatively, or in addition, determining the expected cost based on the at least one comorbidity condition may comprise (i) determining an expected number of units of a medical care procedure based on a comorbidity multiplier and (ii) determining a total expected cost of providing the expected number of units of the procedure. In one example, a first or base expected number of units of a medical care procedure are determined (e.g., by reference to medical care component data 292) and a second expected number of units is determined by multiplying the base number of units by the comorbidity multiplier. The total expected cost can be determined then by multiplying the second number of expected units by an appropriate per unit cost for the procedure, as discussed above.

In one example, a base per unit cost of a treatment procedure for a medical injury claim is determined by reference to medical care component data 292 (e.g., using a type of injury, a geographic region and a selected pricing scheme) and the comorbidity coefficient is determined based on the at least one comorbidity determined in 602 (e.g., by reference to example data structure 400 in FIG. 4A or example data structure 450 in FIG. 4B).

In some embodiments, determining the expected cost based on the at least one comorbidity condition may comprise (i) determining health information for a particular individual and/or (ii) determining a degree of a comorbidity condition. In one embodiment, health and other medical information specific to a particular individual (e.g., an injured worker) may be received from a third party (e.g., a health care provider) via a third-party device 106, received from the injured worker, and/or stored on server computer 102. In one embodiment, as discussed above in reference to FIG. 4B and exemplary data structure 450, more precise comorbidity condition coefficients may be developed based on a measured degree of a given condition. Accordingly, rather than relying on an example comorbidity coefficient of 2.17 for the mere existence of an obesity primary comorbidity condition, the obesity comorbidity coefficient for a particular injured worker may be higher (e.g., 2.21) or lower (e.g., 2.11) depending on whether measurements or other information about the worker's health indicates the worker is very obese (e.g., a level 5), or only slightly overweight (e.g., a level 1). The base cost may then be multiplied, in the manner described above, by the more specific obesity comorbidity coefficient for that worker to derive expected costs of treatment.

In some embodiments, the determined expected cost of the medical injury claim (and/or of any determined per unit cost or expected numbers of units) may be communicated to a client computer, server computer, third-party data device and/or to a claim professional or other user (e.g., represented on a display device of a computer).

Referring now to FIG. 7, a flow diagram of a method 700 according to some embodiments is shown. The method 700 may, for example, be performed by or on behalf of an insurer, a claim professional, a medical care facility and/or an insured person or other user. For purposes of brevity, the method 700 will be described herein as being performed by a computer (e.g., a client computer operated by a claim professional) on behalf of an insurance company. It should be noted that although some of the steps of method 700 may be described herein as being performed by a client computer while other steps are described herein as being performed by another computing device, any and all of the steps may be performed by a single computing device which may be a client computer, server computer, third party data device or another computing device. Further any steps described herein as being performed by a particular computing device may be performed by a human or another computing device as appropriate.

According to some embodiments, the method 700 may comprise determining an age of an injured person associated with a medical injury claim, at 702. Determining the age may comprise one or more of: reviewing the injured person's medical history, accessing stored electronic data including information about the injured person's health; receiving an indication of the age via a user interface (e.g., from a claim professional or other user) or input device; and receiving a signal including an indication of the age from a client computer, server computer, medical cost assessment system or third-party data device.

In one example of determining the age, a claim professional enters the age via a user interface (e.g., by typing the age in a text box, by selecting an appropriate age group from a dropdown menu of selectable age groups). In another example, a medical cost assessment application sends a request (e.g., including information identifying the injured person) to a computer (e.g., a server computer) for the age of the injured person and the server returns the age. In yet another example, historical medical claim data is reviewed and/or analyzed and an indication of an injured person's age is stored (e.g., for analyzing the historical data set to derive age coefficients).

According to some embodiments, the method 700 may comprise determining an expected cost of the medical injury claim based on the age, at 704. Various processes for determining the expected cost with respect to a comorbidity coefficient are discussed above with respect to method 600 of FIG. 6 and elsewhere in this disclosure, and may be used similarly with an age coefficient in place of or in addition to a comorbidity coefficient. In one example, a base per unit cost of a treatment procedure for a medical injury claim is determined by reference to medical care component data 292 (e.g., using a type of injury, a geographic region and a selected pricing scheme) and the age coefficient is determined based on the age determined in 702 (e.g., by reference to example data structure 500 in FIG. 5).

Referring now to FIG. 8, a flow diagram of a method 800 according to some embodiments is shown. The method 800 may, for example, be performed by or on behalf of an insurer, a claim professional, a medical care facility and/or an insured person or other user. For purposes of brevity, the method 800 will be described herein as being performed by at least one computer (e.g., a client computer operated by a claim professional) on behalf of an insurance company. It should be noted that although some of the steps of method 800 may be described herein as being performed by a client computer while other steps are described herein as being performed by another computing device, any and all of the steps may be performed by a single computing device which may be a client computer, server computer, third party data device or another computing device. Further any steps described herein as being performed by a particular computing device may be performed by a human or another computing device as appropriate.

According to some embodiments, the method 800 may comprise determining a type of injury to a person (e.g., associated with a medical injury claim), at 802. Determining the type of injury may comprise one or more of: reviewing the injured person's medical history, accessing stored electronic data including information about the injured person's health; receiving an indication of the type of injury via a user interface (e.g., from a claim professional or other user) or input device; and receiving a signal including an indication of the type of injury from a client computer, server computer, medical cost assessment system or third-party data device.

Types of injuries that may be entered, stored and/or assessed in accordance with various embodiments of the present invention may include, but are not limited to, one or more of the following:
ACL Tear
Ankle Complex/Crush Fracture
Ankle Simple Fracture
Ankle Strain/Sprain
Carpal Tunnel Non Surgical
Carpal Tunnel Surgical
Cervical Disc No Surgery
Cervical Disc Surgery
Cervical Fusion
Cervical Strain/Sprain Whiplash
Elbow Complex/Crush Fracture
Elbow Simple Fracture
Elbow Strain/Sprain
Femur Complex/Crush Fracture
Femur Simple Fracture
Finger Complex/Crush Fracture
Finger Simple Fracture
Finger Strain/Sprain
Foot Complex/Crush Fracture
Foot Simple Fracture
Foot Strain/Sprain
Hand Complex/Crush Fracture
Hand Simple Fracture
Hand Strain/Sprain
Hernia
Hip Fracture
Hip Strain/Sprain
Humerus Complex/Crush Fracture
Humerus Simple Fracture
Knee Fracture
Knee Strain/Sprain
Lumbar Disc No Surgery
Lumbar Disc Surgery
Lumbar Fusion
Lumbar Spine Strain/Sprain
Meniscus Tear
Radius & Ulna Complex/Crush Fracture
Radius & Ulna Simple Fracture
Rotator Cuff Tear Partial or Full
Shoulder Strain/Sprain
Tibia/Fibula Complex/Crush Fracture
Tibia/Fibula Simple Fracture
Toe Complex/Crush Fracture
Toe Simple Fracture
Toe Strain/Sprain
Wrist Complex/Crush Fracture
Wrist Simple Fracture
Wrist Strain/Sprain

In one example of determining the type of injury, a claim professional enters the type of injury via a user interface (e.g., by entering the type of injury in a text box, by selecting a type of injury from a displayed list of selectable injury types). In another example, a medical cost assessment application sends a request (e.g., including information identifying the injured person) to a computer (e.g., a server computer) or claim management system for the injury that is the subject of the claim and the server returns the type of injury. In yet another example, historical medical claim data is reviewed and/or analyzed and an indication of a type of injury is stored (e.g., for analyzing the historical data set to determine appropriate treatment procedures and/or other medical care components).

According to some embodiments, the method 800 may comprise determining (1) at least one comorbidity associated with the person and (2) an age of the person, at 804. Various processes for determining comorbidity conditions and ages of injured persons, and their respective multipliers, are discussed in this disclosure and also with respect to method 600 of FIG. 6 and method 700 of FIG. 7; other ways of deriving such information will be readily understood by those skilled in the art upon consideration of this disclosure.

According to some embodiments, the method 800 may comprise determining at least one component of medical treatment for the type of injury, at 806. In one example of determining the at least one component of medical treatment for a type of injury, a processor (e.g., of a server computer) receives an indication of a type of injury and identifies (e.g., in a database of medical care component data 292) at least one diagnostic procedure, treatment procedure, prescription and/or DME based on the received type of injury (and/or based on an indication of a geographic region (e.g., state, ZIP code, carrier locality) and/or insurance line of business). In another example, a claim professional enters the at least one component via a user interface (e.g., by entering the component in a text box, by selecting a component from a displayed list of selectable components). In yet another example, historical medical claim data is reviewed and/or analyzed and an indication of at least one medical care component is stored (e.g., for analyzing the historical data set to determine appropriate treatment procedures and/or other medical care components, for establishing medical care component data 292).

According to some embodiments, the method 800 may comprise determining an expected cost of the at least one component based on (1) the at least one comorbidity and (2) the age of the person, at 808. Various processes for determining the expected cost with respect to comorbidities and to age are discussed above with respect to method 600 of FIG. 6, method 700 of FIG. 7 and elsewhere in this disclosure, and may be used similarly with respect to determining expected costs for one or more particular components of medical treatment. In some embodiments, age and comorbidity multipliers may be applied to a base expected number of units of each at least one determined component to derive expected numbers of units for each procedure that take into account the potential increased usage of particular procedures because of a patient's age and/or comorbidity factors. In other embodiments, a determined cost of providing all baseline recommended instances of a procedure may be multiplied by age and/or comorbidity coefficients to determine an updated total expected cost of providing the procedure(s). In one embodiment, a combined multiplier (e.g., a result of multiplying one or more applicable multipliers or coefficients) may be associated with a particular person, injured person, claimant and/or insured. For example, a combined multiplier of 2.6875 may be stored in association with a policy holder, representative of a corresponding age coefficient of 1.25 and comorbidity coefficient of 2.15.

Referring now to FIG. 9A and FIG. 9B, a flow diagram of a method 900 according to some embodiments is shown. According to some embodiments, the method 900 may comprise determining a type of bodily injury associated with a claim of an injured person, at 902. At 904, a geographic region associated with treatment of the bodily injury is determined, for example, by receiving via a user interface (e.g., from a claim professional or other user) an indication of a geographic region such as, for example and without limitation, a state and/or ZIP code corresponding to the injured person, the venue of treatment, a location of a medical care facility, and a residential or business address of an insured or claimant. Determining a geographic region may comprise, in some embodiments, receiving a first identifier of a geographic region and determining at least one other identifier of a geographic region based on the first identifier, such as by receiving a ZIP code and referencing the ZIP code in a data store to identify a corresponding state containing the ZIP code.

In some embodiments the method 900 may comprise determining an insurance line of business associated with the claim, at 906. For example, an indication of the line of business may be received via a user interface from a claim professional, from a claim management system (e.g., by cross-referencing in a claim information data store a claim number and/or claimant information entered by a user) and/or based on an identifier that identifies a claim professional and/or client or server computer (e.g., particular users and/or devices may be associated with a particular line or lines of business).

The method 900 may comprise determining an age coefficient associated with the injured person, at 908, and/or determining a comorbidity coefficient associated with the injured person, at 910, as discussed with respect to various embodiments in this disclosure (e.g., accessing coefficient data 294 based on an age and/or comorbidity conditions of the injured person). In some embodiments, multipliers for both age and comorbidity conditions are applied. In some embodiments, if there are no comorbidity conditions, then only an age coefficient is used. In other embodiments, if any comorbidity conditions are present, then only the multiplier(s) associated with the comorbidity condition(s) may be used, without any age coefficient. Applicants have found, unexpectedly, that in general using only a comorbidity multiplier for injured persons with one or more comorbidity conditions provides for more accurate projections of medical costs than also including an age coefficient.

Continuing with the method 900 on FIG. 9B, the method may comprise determining a unit price of a medical care component for treating the bodily injury, at 912, and may comprise determining a base expected number of units of the medical care component, at 914. In some embodiments, determining the unit price and/or determining the base expected number of units may comprise querying medical care component data 292 based on one or more of: the type of bodily injury, the geographic region and/or the insurance line of business. The insurance line of business and/or geographic region, for example, may be used in determining one or more per unit price amounts for a given component, based on the pricing scheme(s) appropriate for the line of business and/or jurisdiction.

In some embodiments the method 900 may comprise determining a total expected cost of the medical care component based on at least one personal health multiplier or coefficient (e.g., the age coefficient and/or the comorbidity coefficient), the per unit price and the based expected number of units, at 916. In one example, determining the total expected cost based on those particular factors may comprise looking up or retrieving the expected cost from a database (e.g., medical care component data 292).

In another example, a total expected cost of an MRI procedure component may be calculated by using a health multiplier that is either an age coefficient or a comorbidity coefficient, depending on whether any comorbidity conditions are present, in accordance with the following equation:

Total expected cost of component=(Health multiplier)×(Per unit price of component)×(Base Expected Number of Units)

For example, if an injured worker has an obesity comorbidity condition, the corresponding comorbidity coefficient may be used as the health multiplier. Alternatively, if the injured worker does not have any comorbidity conditions, the age coefficient may be used as the health multiplier

In some embodiments a health multiplier may comprise both an age coefficient and a comorbidity coefficient. For example, a total expected cost of an MRI procedure component may be calculated in accordance with the following equation:

$$Total expected cost of component = [ \begin{matrix}( Age coefficient ) \times \\ ( Comorbidity coefficient )\end{matrix} ] \times ( Per unit price of component ) \times ( Base expected number of units )$$

For instance, the total expected cost of an MRI procedure component may be determined by multiplying a determined per unit price of $1250.00 by an age coefficient of 1.35, and by a comorbidity coefficient of 2.17, and by a base expected number of units of 1, for a total of $3661.87.

As discussed with respect to some embodiments, it may be desirable to determine an expected number of units by applying the age and/or comorbidity coefficients to a base expected number of units, and, optionally, communicating the expected number of units (e.g., via a user interface to a claim professional). Of course, in accordance with the equation above, this expected number of units may then be multiplied by the per unit price to provide the total expected cost of the component. Similarly, it may be desirable to calculate separately a per unit price by applying any coefficients (e.g., for display); the per unit price may then be multiplied by the base expected number of units to determine a total expected cost of the component.

Referring now to FIG. 10, a flow diagram of a method 1000 according to some embodiments is shown. The method 1000 may, for example, be performed by or on behalf of an insurer, a claim professional, a medical care facility and/or an insured person or other user, in order to establish one or more types of information (e.g., in one or more databases) that may be useful, in one or more embodiments, in assessing medical costs of claims. It should be noted that although some of the steps of method 1000 may be described herein as being performed by a server computer while other steps are described herein as being performed by another computing device, any and all of the steps may be performed by a single computing device which may be a client computer, server computer, third party data device or another computing device. Further any steps described herein as being performed by a particular computing device may be performed by a human or another computing device as appropriate.

In some embodiments method 1000 may comprise collecting historical cost and patient data for a medical care procedure for treating a bodily injury, at 1002. For example, historical claim and patient information stored by one or more insurance companies and/or hospitals or other medical care facilities may be selected and/or aggregated, such claim information including one or more of: amounts paid in treating respective injuries, indications of patient comorbidities present with the injury, ICD-9 codes associated with injuries, CPT codes related to medical treatment of injuries, indications of medical care procedures provided in treating an injury and/or patient ages.

Method 1000 may comprise determining and storing an average historical cost of a medical cost procedure, at 1004. For example, based on a set of historical cost information related to a particular medical care procedure (e.g., a hand X-ray), the number of procedures paid for and the total paid cost for all the procedures may be determined, and the average paid amount may be determined by dividing the total paid cost by the number of procedures paid for. Storing an average historical cost (or average paid amount) may comprise storing an average paid amount in medical care component data 292 in association with the corresponding medical care procedure and, if desirable, in association with a geographic region and/or type of bodily injury.

In some embodiments method 1000 may comprise deriving a comorbidity coefficient for at least one comorbidity condition based on the historical cost and patient data and storing the comorbidity coefficient, at step 1006. Deriving the comorbidity coefficient may comprise identifying patient records in the collected historical data indicating one or more particular comorbidity conditions, such as obesity, diabetes mellitus or osteoporosis. Controlling for such variables, using well known techniques for statistical analysis, a coefficient for a given comorbidity condition may be determined (e.g., by or on behalf of an insurance company, medical care provider, or third party data service) to represent the variation from the costs incurred treating other injured persons without that condition. Some data analysis techniques for identifying significant variables and/or controlling for variables to derive coefficients and other quantitative and qualitative descriptions of relationships among data populations are described in Tamhane and Dunlop, Statistics and Data Analysis from Elementary to Intermediate, Prentice Hall, 2000 and in Kamber, M., Data mining: Concepts and Techniques, Morgan-Kaufman, 2000, each of which is incorporated herein by reference. In some embodiments, patient/claimant segmentation and other data analysis, data management and data mining processes may rely on and/or adapt commercially available processes and products, such as the STATISTICA suite of analytics software products by StatSoft, Inc.

In one example analysis, an insurance company wants to determine a coefficient that may be useful in projecting the medical costs of injured persons who also have a diabetes mellitus condition. The company stores or otherwise has access to a database (or databases) of information on past injury claims paid, and corresponding medical information for the injured persons. The company identifies, for types of injuries of interest (e.g., all bodily injuries, the fifty most common musculoskeletal injuries), a population of the injured persons who had diabetes mellitus at the time of their injuries, and identifies a second sample of injured persons who did not have diabetes mellitus. In one example, a frequency distribution (e.g., as a histogram) of costs for treatment for all types of injuries may be determined for patients without the diabetes condition (e.g., as a control) and the distribution may be compared to a frequency distribution of the costs for treatment for patients with the diabetes condition to derive a coefficient using any of various well known techniques. In another example, costs of treatment for all types of injuries may be determined to be $1,000,000 for the patients without the diabetes condition, and $2,150,000 for the patients with diabetes mellitus. Comparing the total costs for the two groups ($2,150,000/$1,000,000, or 2.15:1) indicates that medical costs for treating patients who suffer the injuries of interest and who also have diabetes mellitus will be, on average, 2.15 times more expensive than the costs for treating patients without that diabetes condition. The derived coefficient preferably is stored in association with the corresponding diabetes mellitus condition (e.g., in a database) for use in assessing medical costs for injury claims. Alternatively, or in addition, such coefficients may be derived periodically or in real-time based on current data, as desired for particular implementations.

Coefficients representing the presence of different primary comorbidities and/or multiple comorbidities may be derived similarly by analyzing the historical cost data associated with patients having such conditions in light of the cost data associated with patients without such conditions. Comorbidity coefficients may be stored, in some embodiments, as coefficient data 294, e.g., as depicted in example data structure 400 in FIG. 4A or example data structure 450 in FIG. 4B.

In some embodiments method 1000 may comprise deriving an age coefficient for at least one age or age group based on the historical cost and patient data and storing the age coefficient, at step 1008. Deriving the age coefficient may comprise identifying patient records in the collected historical data indicating ages of patients. As discussed above, controlling for age (and/or age groupings) using well known techniques for statistical analysis, respective coefficients for one or more age groups may be determined to represent the variations among the number of a particular procedure used (and/or other costs incurred) in treating injured persons of various ages and/or in various age groups. Age coefficient or coefficients may be stored, in some embodiments, as coefficient data 294, e.g., as depicted in example data structure 500 in FIG. 5.

Applicants have recognized that the mapping of particular, common bodily injuries to particular procedures, in accordance with established treatment guidelines and/or historical claim information, and the association of each bodily injury with its respective procedures (e.g., in a database), allows advantageously, in accordance with some embodiments, for a single concise source for a claim professional and other users for the diagnostics, treatment and other related costs for injuries commonly encountered in claims. The mapping further provides for consistency in presenting a set of recommended procedures for a particular type of injury, and may avoid some of the inconsistencies and errors made by claim professionals who would otherwise rely on their independent judgment to identify relevant procedures, using personal knowledge and sources that may be not be accessible to other professionals, even within the same organization.

In some embodiments method 1000 may comprise establishing medical care component data associating types of bodily injury with one or more medical care procedures, at 1010. Establishing the medical care component data may comprise storing the medical care component data in one or more databases, computers and/or third-party data devices. According to one embodiment, establishing the medical care component data comprises: (i) determining one or more diagnosis codes (e.g., ICD-9 codes) relevant to a particular type of bodily injury; and (ii) mapping, “cross-walking” or otherwise associating one or more corresponding diagnostic and treatment procedures to each respective determined diagnosis code (e.g., by associating one or more appropriate CPT codes with each ICD-9 diagnosis code assigned to a bodily injury), thereby establishing a set of one or more procedures for each bodily injury.

In some embodiments, establishing the medical care component data further comprises one or more of the following: (i) determining, for each associated procedure, an expected number of that procedure necessary to treat the bodily injury (e.g., based on standard medical treatment guidelines and/or historical claim data) and/or storing an indication of the association between the procedure and the expected number of that procedure; (ii) determining, for each associated procedure, at least one per unit cost of the procedure and/or storing an indication of the association between the procedure and the at least one per unit cost; and (iii) determining, for each associated procedure, at least one geographic region associated with a per unit cost of the procedure and/or storing an indication of the association between the at least one geographic region and the per unit cost. In some embodiments, storing an indication of an association comprises storing representations of the associated information in a data store, such as by storing related information in a database record (e.g., of data structure 300 in FIG. 3).

According to one or more embodiments, the association of injury types with corresponding diagnostic codes (e.g. ICD-9 codes) and/or procedure codes (e.g., CPT codes) may be stored in one or more databases. In one example, as indicated in the following table, a data structure may store an identifier (e.g., a text description, an alphanumeric code) that identifies an injury in association with one or more ICD-9 codes:

| Injury Type ID | Injury Type Description | ICD-9 Codes |
|---|---|---|
| IT-001 | ACL Tear | 844; 844.2; 717.9; 717.81; |
| | | 717.82; 717.83; 717.84; |
| | | 717.85 |
| IT-002 | Ankle | 845; 845.0; 845.01; 845.02; |
| | | 845.03 |
| IT-003 | Ankle Simple | 824; 824.0; 824.2; 824.4; |
| | | 824.8 |
| IT-004 | Carpal Tunnel | 354 |
| IT-006 | Cervical | 847 |
| IT-007 | Cervical Disc | 722; 722.91; 722.71 |
| IT-009 | Cervical Fusion | 722; 722.91; 722.71 |
| IT-010 | Elbow | 726.31; 726.32; 726.33; 841; |
| | | 841.0; 841.1 |
| IT-011 | Elbow Simple | 812; 812.4; 812.41; 812.42; |
| | | 812.43; 812.44 |
| IT-021 | Hand Strain/Sprain | 842; 842.1; 842.11; 842.12; |
| | | 842.13 |

In another example, as indicated in the following table, a data structure may store an identifier that identifies an injury in association with one or more CPT codes or other identifiers for identifying procedures and/or descriptions of procedures.

| | | | | | Average | Average |
|---|---|---|---|---|---|---|
| Injury | Injury Type | Procedure | | Number of | Cost per | Total |
| Type ID | Description | Description | CPT Codes | Procedures | Procedure | Cost |
| IT-021 | Hand Strain/Sprain | Office visit, new | 99201, | 3 | 68.75 | 206.26 |
| | | | 99202 | | | |
| IT-021 | Hand Strain/Sprain | Office visit | 99211, | 3 | 41.80 | 125.40 |
| | | | 99212 | | | |
| IT-021 | Hand Strain/Sprain | X-rays, hand | 73120, | 2 | 31.14 | 62.28 |
| | | | 73130 | | | |
| IT-021 | Hand Strain/Sprain | Application splint | 29125 | 1 | 64.08 | 64.08 |
| IT-021 | Hand Strain/Sprain | Occupational | 97003, | 2 | 62.41 | 124.82 |
| | | | 97004 | | | |
| IT-003 | Ankle Simple | Office visit, new | 99201, | 3 | 68.75 | 206.26 |
| | | | 99202 | | | |
| IT-003 | Ankle Simple | Office visit | 99211, | 3 | 41.80 | 125.40 |
| | | | 99212 | | | |
| IT-003 | Ankle Simple | X-rays, ankle | 73600, | 4 | 30.85 | 123.38 |
| | | | 73610 | | | |
| IT-003 | Ankle Simple | MRI, lower | 73718, | 6 | 731.52 | 4389.09 |
| | | | 73723 | | | |
| IT-003 | Ankle Simple | Closed reduction | 27760, | 3 | 285.53 | 856.59 |
| | | | 27767 | | | |
| IT-003 | Ankle Simple | Application cast | 29590, | 3 | 78.55 | 235.64 |
| | | | 29405 | | | |
| IT-003 | Ankle Simple | Physical Therapy | 97001, | 2 | 56.98 | 113.96 |
| | | | 97002 | | | |

In another example, as will be readily understood by those skilled in the art, one data structure may store at least the information described in the preceding examples (e.g., an injury type ID may be stored in a record with one or more ICD-9 codes) and one or more CPT codes or other identifiers of corresponding medical procedures.

According to some embodiments described in this disclosure, systems, methods, computer readable mediums and apparatus may provide for one or more of the following features:

(i) in which determining an indication of an injury type comprises one or more of:

receiving the indication of the injury type from a user via a user interface,

receiving the indication of the injury type via a webpage,

receiving the indication of the injury type from a client computer,

receiving the indication of the injury type by a client computer,

receiving the indication of the injury type from a server computer,

receiving the indication of the injury type by a server computer,

receiving the indication of the injury type from a web server,

receiving the indication of the injury type by a web server, and

receiving a selection by a user of the injury type from a plurality of selectable injury types;

and/or

(ii) in which determining a medical procedure associated with the injury comprises one or more of:

receiving an indication of the medical procedure from a user via a user interface,

receiving an indication of the medical procedure via a webpage,

receiving an indication of the medical procedure from a client computer,

receiving an indication of the medical procedure by a client computer,

receiving an indication of the medical procedure from a server computer,

receiving an indication of the medical procedure by a server computer,

receiving an indication of the medical procedure from a web server,

receiving an indication of the medical procedure by a web server,

receiving a selection by a user of the medical procedure from a plurality of selectable medical procedures,

transmitting, to a server computer, an indication of the injury type,

receiving, by a server computer, an indication of the injury type, and

accessing a database storing an indication of the injury type in association with at least one corresponding medical procedure;

and/or

(iii) in which determining a per unit cost of the medical procedure comprises one or more of:

receiving an indication of the per unit cost from a user via a user interface,

receiving an indication of the per unit cost via a webpage,

receiving an indication of the per unit cost from a client computer,

receiving an indication of the per unit cost by a client computer,

receiving an indication of the per unit cost from a server computer,

receiving an indication of the per unit cost by a server computer,

receiving an indication of the per unit cost from a web server,

receiving an indication of the per unit cost by a web server,

receiving a selection by a user of the per unit cost from a plurality of selectable per unit costs associated with the medical procedure,

transmitting, to a server computer, an indication of at least one of the injury type, the medical procedure, and a geographic region,

receiving, by a server computer, an indication of at least one of the injury type, the medical procedure, and a geographic region, and

accessing a database storing an indication of the per unit cost in association with the medical procedure;

and/or

(iv) in which determining a first expected number of units of the medical procedure comprises one or more of:

receiving an indication of the first expected number of units from a user via a user interface,

receiving an indication of the first expected number of units via a webpage,

receiving an indication of the first expected number of units from a client computer,

receiving an indication of the first expected number of units by a client computer,

receiving an indication of the first expected number of units from a server computer,

receiving an indication of the first expected number of units by a server computer,

receiving an indication of the first expected number of units from a web server,

receiving an indication of the first expected number of units by a web server,

receiving a selection by a user of the first expected number of units from a plurality of selectable numbers of units associated with the medical procedure,

transmitting, to a server computer, an indication of at least one of the injury type, the medical procedure, a geographic region, an insurance line of business, and an occupation type,

receiving, by a server computer, an indication of at least one of the injury type, the medical procedure, a geographic region, an insurance line of business, and an occupation type, and

accessing a database storing an indication of the first expected number of units in association with at least one of the injury type, the medical procedure, a geographic region, an insurance line of business, and an occupation type;

and/or

(v) in which determining at least one of (i) an indication of an age of a person and (ii) at least one comorbidity condition associated with the person comprises one or more of:

receiving, from a user via a user interface, at least one of: an indication of an age of the person and an indication of the at least one comorbidity condition,

receiving, via a webpage, at least one of: an indication of an age of the person and an indication of the at least one comorbidity condition,

receiving, from a client computer, at least one of: an indication of an age of the person and an indication of the at least one comorbidity condition,

receiving, by a client computer, at least one of: an indication of an age of the person and an indication of the at least one comorbidity condition,

receiving, from a server computer, at least one of: an indication of an age of the person and an indication of the at least one comorbidity condition,

receiving, by a server computer, at least one of: an indication of an age of the person and an indication of the at least one comorbidity condition,

receiving, from a web server, at least one of: an indication of an age of the person and an indication of the at least one comorbidity condition,

receiving, by a web server, at least one of: an indication of an age of the person and an indication of the at least one comorbidity condition,

receiving a selection by a user of an age group from a plurality of selectable age groups,

receiving a selection by a user of the at least one comorbidity condition from a plurality of selectable comorbidity conditions,

transmitting, to a server computer, an identifier that identifies the person,

receiving, by a server computer, an identifier that identifiers the person, and

accessing a database storing an indication of at least one of the age of the person and the at least one comorbidity condition in association with an identifier that identifies the person;

and/or

(vi) in which determining a total expected cost of the medical procedure comprises one or more of:

receiving an indication of the total expected cost of the medical procedure from a user via a user interface,

receiving an indication of the total expected cost of the medical procedure via a webpage,

receiving an indication of the total expected cost of the medical procedure from a client computer,

receiving an indication of the total expected cost of the medical procedure by a client computer,

receiving an indication of the total expected cost of the medical procedure from a server computer,

receiving an indication of the total expected cost of the medical procedure by a server computer,

receiving an indication of the total expected cost of the medical procedure from a web server, and

receiving an indication of the total expected cost of the medical procedure by a web server.

### D. Example System

According to one example system, a medical cost assessment system is integrated as a module or sub-system of a centralized claim management system, such as ClaimNet of Travelers Insurance. Integration with a claim management system may allow advantageously for pre-filling, in a user interface for the medical cost assessment system, information retrieved from the claim management system, such as name, claim number, state and/or ZIP code, and may further provide for storing the medical cost assessment results with the main claim file in the claim management system.

According to one example system, a medical cost assessment system includes an electronic spreadsheet file, such as a Microsoft® Excel® workbook file, as its user interface. The example system also includes, and the spreadsheet retrieves information from, one or more databases, such as a Microsoft® Access® database file, using Microsoft® OLE DB technology and Microsoft® Visual Basic® for Applications (VBA). When the user selects an injury type and geographic region (e.g., ZIP code) in the Excel® workbook and then initiates updating of the workbook (e.g., by using an input device to actuate a corresponding interface element), VBA code is executed to retrieve pricing information from the database(s), update the workbook with the retrieved information and, if necessary, perform additional processing of the retrieved information (e.g., calculating total costs of procedures and/or a claim).

### E. Example Interfaces and Applications

Any or all of methods 600, 700, 800, 900 and 1000 may involve one or more interface(s), and the methods may include, in some embodiments, providing an interface through which a user may be allowed to enter one or more of a type of injury, age of an injured person, at least one comorbidity condition, insurance line of business, gender of an injured person, geographic region, and/or any other information about a claim or injury associated with a claim.

According to one example method, a claim professional responsible for handling a claim for a bodily injury accesses (e.g., using a smartphone, desktop or laptop computer) a user interface for generating diagnostics, treatment and pricing information appropriate for the claim. The user interface may be implemented, for example, as a spreadsheet in a spreadsheet application, as a smartphone application and/or as a component or module of a centralized, claim data entry system. The interface includes form fields and other interface elements allowing the claim professional to enter data associated with the claim. The claim professional enters a type of bodily injury. In one example, the claim professional selects the type of bodily injury from a dropdown menu containing a plurality of available injury types (e.g., cervical strain/sprain whiplash, finger injury). The claim professional also enters the following:
a. a zip code (e.g., corresponding to the venue of treatment)
b. an age group of the claimant (e.g., less than 40 years old, 40 to 59 years old, 60 to 74 years old, 75 years old and over)
c. a insurance line of business relevant to the claim (e.g., WC, auto liability, general liability, auto non-fault, personal injury protection, first party medical)
d. an indication of whether the claimant is associated with any comorbidity factors (e.g., none, diabetes mellitus, obesity/nutritional issues).

Optionally, the claim professional may also enter one or more of the following: a gender of the claimant, the claimant's name, an identifier uniquely associated with the claim (e.g., a claim number), an indication of an expected number of days the claimant will be unable to work and/or an indication of the physical demands of the claimant's occupation (e.g., light, medium, heavy).

The claim professional then submits the claim information for processing in order to receive suggested treatment and pricing information for the claim. For example, the claim professional may use a pointer device or other input to device to click a button, or otherwise initiate processing of the claim information via the interface.

In response, and based on the provided information, the application returns one or more suggested procedures, corresponding pricing information, an expected number of each procedure and a respective indication for whether each procedure should have coefficients/multipliers applied to the respective expected number. If coefficients are to be applied, the application multiplies the base expected number of a procedure by an age coefficient and by a comorbidity coefficient (the value of either or both coefficients may be 1.00) and displays the calculated number of the procedure based on the age and/or comorbidity considerations.

Pricing information for each suggested procedure is displayed via the interface based on one or more of the following pricing schemes: an average amount paid for the procedure on claims during a prior time period (e.g., a prior year), a fee schedule recommended amount for the procedure, a UCR recommended amount for the procedure, and a Medicare price for the procedure. Where information for multiple pricing schemes is presented, the interface allows the claim professional to select one pricing scheme for determining a total cost of each procedure by selecting a radio button corresponding to the desired pricing scheme.

The application determines the total cost of each suggested procedure by multiplying the expected number of the procedure by the per unit price (according to the selected pricing scheme) and displays the total costs to the claim professional via the interface. Switching to a different pricing scheme results in a recalculation of the total costs based on the newly-selected pricing scheme. The application also calculates a total cost of all suggested procedures and displays the total cost.

If relevant treatment guidelines are available, the application interface may automatically provide expected medication and/or DME, recommended quantities and their respective costs, based on the information entered by the claim professional. Alternatively, or in addition, the interface may also allow for manual selection by the claim professional of prescriptions, other medications and/or DME. For example, a claim professional may select one or more medications via a search field, a listbox or dropdown combobox, and the application may retrieve the corresponding pricing information for that medication from a database. The claim professional may manually input a quantity of the selected medication(s). Similar functionality and interface elements may be employed for DME and/or other components of medical care related to a claim.

Any recommended components may be displayed advantageously with the medical treatment procedures to provide an outline of all expected components of medical care. A total medical cost of the claim may be determined by summing the respective total costs of each recommended procedure, medication and DME, and the total medical cost may be displayed to the claim professional via the user interface. The user interface may also allow a claim professional to remove any components from the represented components of medical care. For example, if the claim professional determines that a recommended medical treatment procedure is inappropriate for a particular claimant, the user interface may allow the claim professional to delete that component. The user interface may also allow a claim professional to print a listing of the determined components for a claim, to clear all components currently presented and/or to reset the interface for processing a new claim.

FIG. 11A illustrates an example interface 1100 through which a user (e.g., a claim professional) may enter medical injury claim information. Through such an interface 1100 a user may be able to enter one or more of: a claim number, a claimant's name, a type of injury, a ZIP code and/or a state (e.g., associated with a venue of treatment), an indication of the physical demands of an occupation of the injured person, an insurance line of business (e.g., WC insurance), a gender of the injured person, an age of the person, a primary comorbidity and a secondary comorbidity. Although certain types of information are illustrated in the example interface 1100, those skilled in the art will understand that the interface 1100 may be modified in order to provide for additional types of information (e.g., additional comorbidity conditions) and/or to remove some of the illustrated types of information, as deemed desirable for a particular implementation. The example interface 1100 also includes an interface element allowing a user to reset or clear the interface form fields (e.g., by using a pointer or other input device to actuate the “RESET” button). The example interface 1100 also includes an interface element (the “SUBMIT” button) allowing the user to submit information entered via the interface for processing, determination of costs, and display or other communication of recommended medical care components based on all or a portion of the information submitted.

FIG. 11B illustrates an example interface 1150 through which a user (e.g., a claim professional) may be presented with medical injury claim information, such as after the user has submitted information via the example interface of 1100. In some embodiments the user may be allowed to enter information in interface 1150 for assessing the medical cost of a claim. The example interface 1150 provides for the presentation and/or entry of a claim number, a claimant's name, a type of injury, a treatment region (e.g., a ZIP code and/or a state), an indication of the length of time a injured worker is expected to be unable to return to work (e.g., based on the injury type and/or level of physical demands of the job), an insurance line of business, an age multiplier and/or a comorbidity multiplier.

The example interface 1150, in some embodiments, also provides a listing of recommended diagnostic and treatment procedures that the assessment system has identified, for example, in accordance with one or more described embodiments, as being appropriate for a particular injury type, treatment region, and/or line of business. In some embodiments, the user is able to select one of any pricing schemes represented in the displayed information (e.g., a fee schedule set of prices). A procedure description, number of expected units required (base and/or modified based on any coefficients, actual amount paid historically, fee schedule amount, UCR amount, Medicare amount, and total cost for a selected price scheme may be presented. The interface may also provide a total cost of the diagnostics and treatment procedures. Some embodiments provide for additional types of medical care components, such as prescriptions and/or DME, as depicted in example interface 1150, and may also provide for adding additional procedure, prescription, DME or other medical care components (e.g., manually by accessing a vendor system to search relevant prescription and DME items). The example interface 1150 may display or otherwise communicate advantageously a total expected medical cost based on all the listed components of medical care for the injury claim.

Although certain types of information are illustrated in the example interface 1150, those skilled in the art will understand that the interface 1100 may be modified in order to provide for additional types of information (e.g., specific comorbidity conditions) and/or to remove some of the illustrated types of information (e.g., the age and/or comorbidity coefficients), as deemed desirable for a particular implementation.

In some embodiments example interface 1150 may comprise interface elements for returning to a data entry screen (e.g., by pressing a “BACK” button), for saving the presented information to a file (e.g., by pressing the “SAVE” button) and/or for refreshing the displayed information (e.g., by pressing the “REFRESH” button to recalculate totals and/or query stored data). In some embodiments example interface 1150 may comprise interface elements for highlighting, selecting or otherwise identifying one or more displayed components that the user would like to delete (e.g., by clicking an associated checkbox); selected components may be deleted by pressing a corresponding button (e.g., the “DELETE SELECTED” button).

Although interface 1100 and interface 1150 are illustrated as different interfaces, those skilled in the art will readily understand, in light of the present disclosure, that the features and information of both interfaces, or a subset of such features and information, may be included in a single interface, screen display or application window. For example, a single interface window may be used for both inputting relevant claim information, including type of injury, and displaying recommended procedures and other components for that type of injury on the same screen, tab or page of the interface.

### Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

1. An apparatus comprising:
a processor; and
a computer-readable memory in communication with the processor, the computer-readable memory storing instructions that when executed by the processor result in:
determining an indication of an injury type;
determining a medical procedure associated with the injury type;
determining a per unit cost of the medical procedure;
determining a first expected number of units of the medical procedure;
determining at least one of (i) an indication of an age of a person and (ii) at least one comorbidity condition associated with the person; and
determining a total expected cost of the medical procedure, based on the per unit cost of the medical procedure, the first expected number of units of the medical procedure, and at least one of (i) the age and (ii) the at least one comorbidity condition.

2. The apparatus of claim 1, in which determining the medical procedure associated with the injury type comprises:
determining the medical procedure based on the injury type and at least one of: a geographic region and a line of business.

3. The apparatus of claim 1, in which determining the per unit cost of the medical procedure comprises:
determining the per unit cost of the medical procedure based on at least one of: the injury type, the medical procedure, a geographic region, an insurance line of business, and an occupation type.

4. The apparatus of claim 1, in which determining the first expected number of units of the medical procedure comprises:
determining the first expected number of units of the medical procedure based on at least one of: the injury type, the medical procedure, a geographic region, an insurance line of business, and an occupation type.

5. The apparatus of claim 1, in which determining the total expected cost of the medical procedure comprises:
determining the total expected cost of the medical procedure based on the at least one comorbidity condition, the first expected number of units of the medical procedure, the age, and the per unit cost of the medical procedure.

6. The apparatus of claim 1, in which determining the total expected cost of the medical procedure comprises:
determining a multiplier based on at least one of: the age and the at least one comorbidity condition; and
multiplying the first expected number of units of the medical procedure by the multiplier to generate a second expected number of units.

7. The apparatus of claim 6, in which determining the total expected cost of the medical procedure further comprises:
multiplying the second expected number of units of the medical procedure by the per unit cost of the medical procedure.

8. The apparatus of claim 1, in which determining the total expected cost of the medical procedure comprises:
determining a comorbidity multiplier based on the at least one comorbidity condition; and
multiplying the first expected number of units of the medical procedure by the per unit cost of the medical procedure and by the comorbidity multiplier.

9. The apparatus of claim 1, in which determining the total expected cost of the medical procedure comprises:
determining an age multiplier based on the indication of the age; and
multiplying the first expected number of units of the medical procedure by the per unit cost of the medical procedure and by the age multiplier.

10. The apparatus of claim 1,
wherein determining at least one of (i) an indication of an age of a person and (ii) at least one comorbidity condition associated with the person comprises:
determining whether at least one comorbidity condition is associated with the person; and
wherein determining the total expected cost of the medical procedure comprises:
(a) when at least one comorbidity condition is associated with the person,
determining a comorbidity multiplier based on the at least one comorbidity condition, and
multiplying the first expected number of units of the medical procedure by the per unit cost of the medical procedure and by the comorbidity multiplier; and
(b) when no comorbidity condition is associated with the person,
determining an age multiplier based on the indication of the age of the person, and
multiplying the first expected number of units of the medical procedure by the per unit cost of the medical procedure and by the age multiplier.

11. A computer-readable memory storing instructions that when executed by a computer comprising at least one processor result in:
determining an indication of an injury type;
determining, by a computer comprising at least one processor, a medical procedure associated with the injury type;
determining a per unit cost of the medical procedure;
determining a first expected number of units of the medical procedure;
determining at least one of (i) an indication of an age of a person and (ii) at least one comorbidity condition associated with the person; and
determining, by the computer, a total expected cost of the medical procedure, based on the per unit cost of the medical procedure, the first expected number of units of the medical procedure, and at least one of (i) the age and (ii) the at least one comorbidity condition.

12. The computer readable memory of claim 11, in which determining the medical procedure associated with the injury type comprises:
determining the medical procedure based on the injury type and at least one of: a geographic region and a line of business.

13. The computer readable memory of claim 11, in which determining the per unit cost of the medical procedure comprises:
determining the per unit cost of the medical procedure based on at least one of: the injury type, the medical procedure, a geographic region, an insurance line of business, and an occupation type.

14. The computer readable memory of claim 11, in which determining the first expected number of units of the medical procedure comprises:
determining the first expected number of units of the medical procedure based on at least one of: the injury type, the medical procedure, a geographic region, an insurance line of business, and an occupation type.

15. The computer readable memory of claim 11, in which determining the total expected cost of the medical procedure comprises:
determining a multiplier based on at least one of the age and the at least one comorbidity condition;
multiplying the first expected number of units of the medical procedure by the multiplier to generate a second expected number of units; and
multiplying the second expected number of units of the medical procedure by the per unit cost of the medical procedure.

16. The computer readable memory of claim 11, in which determining the total expected cost of the medical procedure comprises:
determining a comorbidity multiplier based on the at least one comorbidity condition; and
multiplying the first expected number of units of the medical procedure by the per unit cost of the medical procedure and by the comorbidity multiplier.

17. The computer readable memory of claim 11, in which determining the total expected cost of the medical procedure comprises:
determining an age multiplier based on the indication of the age; and
multiplying the first expected number of units of the medical procedure by the per unit cost of the medical procedure and by the age multiplier.

18. The computer readable memory of claim 11,
wherein determining at least one of (i) an indication of an age of a person and (ii) at least one comorbidity condition associated with the person comprises:
determining whether at least one comorbidity condition is associated with the person; and
wherein determining the total expected cost of the medical procedure comprises:
(a) when at least one comorbidity condition is associated with the person,
determining a comorbidity multiplier based on the at least one comorbidity condition, and
multiplying the first expected number of units of the medical procedure by the per unit cost of the medical procedure and by the comorbidity multiplier; and
(b) when no comorbidity condition is associated with the person,
determining an age multiplier based on the indication of the age of the person, and
multiplying the first expected number of units of the medical procedure by the per unit cost of the medical procedure and by the age multiplier.

19. The computer readable memory of claim 11, further comprising: presenting the total expected cost of the medical procedure via a user interface.

20. A method comprising:
determining an indication of an injury type;
determining, by a computer comprising at least one processor, a medical procedure associated with the injury type;
determining a per unit cost of the medical procedure;
determining a first expected number of units of the medical procedure;
determining at least one of (i) an indication of an age of a person and (ii) at least one comorbidity condition associated with the person; and
determining, by the computer, a total expected cost of the medical procedure, based on the per unit cost of the medical procedure, the first expected number of units of the medical procedure, and at least one of (i) the age and (ii) the at least one comorbidity condition.

21. The method of claim 20, further comprising: presenting the total expected cost of the medical procedure via a user interface.

22. The method of claim 20, in which determining the medical procedure associated with the injury type comprises:
determining the medical procedure based on the injury type and at least one of: a geographic region and a line of business.

23. The method of claim 20, in which determining the per unit cost of the medical procedure comprises:
determining the per unit cost of the medical procedure based on at least one of: the injury type, the medical procedure, a geographic region, an insurance line of business, and an occupation type.

24. The method of claim 20, in which determining the first expected number of units of the medical procedure comprises:
determining the first expected number of units of the medical procedure based on at least one of: the injury type, the medical procedure, a geographic region, an insurance line of business, and an occupation type.

25. The method of claim 20, in which determining the total expected cost of the medical procedure comprises:
determining a multiplier based on at least one of: the age and the at least one comorbidity condition;
multiplying the first expected number of units of the medical procedure by the multiplier to generate a second expected number of units; and
multiplying the second expected number of units of the medical procedure by the per unit cost of the medical procedure.

26. The method of claim 20, in which determining the total expected cost of the medical procedure comprises:
determining a comorbidity multiplier based on the at least one comorbidity condition; and
multiplying the first expected number of units of the medical procedure by the per unit cost of the medical procedure and by the comorbidity multiplier.

27. The method of claim 20, in which determining the total expected cost of the medical procedure comprises:
determining an age multiplier based on the indication of the age; and
multiplying the first expected number of units of the medical procedure by the per unit cost of the medical procedure and by the age multiplier.

28. The method of claim 20,
wherein determining at least one of (i) an indication of an age of a person and (ii) at least one comorbidity condition associated with the person comprises:
determining whether at least one comorbidity condition is associated with the person; and
wherein determining the total expected cost of the medical procedure comprises:
(a) when at least one comorbidity condition is associated with the person,
determining a comorbidity multiplier based on the at least one comorbidity condition, and
multiplying the first expected number of units of the medical procedure by the per unit cost of the medical procedure and by the comorbidity multiplier; and
(b) when no comorbidity condition is associated with the person,
determining an age multiplier based on the indication of the age of the person, and
multiplying the first expected number of units of the medical procedure by the per unit cost of the medical procedure and by the age multiplier.

29. A method comprising:
determining an indication of an injury type;
determining, by a computer comprising at least one processor, a medical procedure associated with the injury type;
determining a first expected cost of the medical procedure;
determining at least one of (i) an indication of an age of a person and (ii) at least one comorbidity condition associated with the person; and
determining, by the computer, a total expected cost of the medical procedure by adjusting the first expected cost of the medical procedure based on at least one of (i) the age and (ii) the at least one comorbidity condition.

30. The method of claim 29, wherein determining the first expected cost of the medical procedure comprises:
determining a per unit cost of the medical procedure; and
determining a first expected number of units of the medical procedure.

31. The method of claim 29, wherein adjusting the first expected cost of the medical procedure comprises:
determining a multiplier based on at least one of: the age and the at least one comorbidity condition; and
multiplying the first expected cost of the medical procedure by the multiplier.
